(19) United States
(12) Patent Application Publication
(10) Pub. No.: US 2015/0281430 A1
(43) Pub. Date: Oct. 1, 2015

(54) METHOD AND APPARATUS FOR PROVIDING INFORMATION BASED ON MOVEMENT OF AN ELECTRONIC DEVICE

(71) Applicant: Samsung Electronics Co., Ltd., Gyeonggi-do (KR)

(72) Inventors: Hyun Wook Cho, Daegu (KR); Byoung Yong Lee, Seoul (KR); Yoo Ra Kim, Gyeonggi-do (KR); Ho Sam Kim, Gyeonggi-do (KR); Dong Hee Suh, Gyeonggi-do (KR); Kyu Seung Lee, Gyeonggi-do (KR); Gyung Hun Jang, Gyeonggi-do (KR)

(21) Appl. No.: 14/671,976

(22) Filed: Mar. 27, 2015

(30) Foreign Application Priority Data
Mar. 27, 2014 (KR) 10-2014-0035666

(51) Int. Cl. H04M 1/725; G06F 3/041; G01P 3/00

(52) U.S. Cl. CPC H04M 1/72577; G01P 3/00; G06F 3/0416; H04M 1/72569

(57) ABSTRACT

Various embodiments relate to processing of a function based on a movement state of an electronic device. A method according to an embodiment may include receiving information related to movement of an electronic device or an external device outside the electronic device. The method also includes differently controlling, on the basis of the information, a function of an input device or output device of the electronic device or the external device, an application to be executed in the electronic device or the external device, or at least a part of a function of the application, with respect to a message received by the electronic device, by using at least one process. Other embodiments are possible.

### CROSS-REFERENCE TO RELATED APPLICATION(S) AND CLAIM OF PRIORITY

The present application is related to and claims priority under 35 U.S.C. §119(a) to Korean Patent Application No. 10-2014-0035666 filed on Mar. 27, 2014 in the Korean Intellectual Property Office, the entire disclosure of which is hereby incorporated by reference.

### TECHNICAL FIELD

Various embodiments of the present disclosure relate to a method for operating an electronic device for providing various information on the basis of a state of the electronic device.

### BACKGROUND

Users may walk or exercise while carrying portable electronic devices. Furthermore, the users may carry the electronic devices in vehicles such that the electronic devices operate independently or in association with other electronic devices of the vehicles, such as navigation devices.

### SUMMARY

As described above, users frequently use (e.g., calling or sending/receiving messages) electronic devices (e.g., smartphones) while the users are in motion (e.g., walking, exercising or driving). However, the electronic devices may distract the users from their surroundings, causing accidents.

To address the above-discussed deficiencies, it is a primary object to provide a safe use environment to a user or surroundings of the user (e.g., surrounding people, buildings or vehicles) by restricting or modifying provision of information by an electronic device on the basis of a movement state of the electronic device.

An electronic device according to an embodiment may include a memory and a controller. The memory stores information related to movement of the electronic device or an external device outside the electronic device. The controller is functionally connected to the memory. The controller differently controls, on the basis of the information, a function of an input device or an output device of the electronic device or the external device, an application to be executed in the electronic device or the external device, or at least a part of a function of the application with respect to a message received by the electronic device.

An information providing method based on a movement state includes receiving information related to movement of an electronic device or an external device outside the electronic device. The method also includes differently controlling, on the basis of the information, a function of an input device or output device of the electronic device or the external device, an application to be executed in the electronic device or the external device, or at least a part of a function of the application, with respect to a message received by the electronic device, by using at least one process.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a diagram showing an information providing system based on a movement state according to an embodiment.

FIG. 2 illustrates a schematic block diagram showing an electronic device according to an embodiment.

FIG. 3 illustrates a diagram showing a control module according to an embodiment.

FIG. 4 illustrates a process for providing information based on a movement state according to an embodiment.

FIG. 5a illustrates a process for providing information based on a movement state in relation to a communication message according to an embodiment.

FIG. 5b illustrates a process for providing information based on a movement state using guide information according to various embodiments.

FIG. 5c illustrates a process for providing information based on a movement state according to the various embodiments.

FIG. 6 illustrates a process for operating a system based on a movement state according to an embodiment.

FIG. 7 illustrates a process for operating a system based on a movement state in relation to a communication message according to an embodiment.

FIG. 8 illustrates a diagram showing a screen interface related to processing of a communication message based on a movement state according to an embodiment.

FIG. 9 illustrates a diagram showing an operation of processing function performance screen data based on a movement state according to an embodiment.

FIG. 10 illustrates a diagram showing an operation of processing function performance screen data based on a movement state according to an embodiment.

FIG. 11 illustrates a diagram showing a screen interface related to processing of a communication message based on a movement state according to the various embodiments.

FIG. 12 illustrates a block diagram showing an electronic device according to the various embodiments.

### DETAILED DESCRIPTION

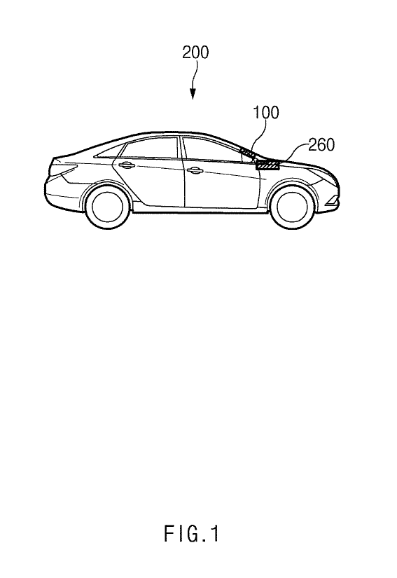

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system and method. Hereinafter, various embodiments of the present disclosure will be described with reference to the accompanying drawings. The present disclosure may be variously modified and may include various embodiments. However, specific embodiments are exemplarily illustrated in the drawings and detailed descriptions related thereto are provided. However, it should be understood that the various embodiments of the present disclosure are not limited to specific examples but rather include all modifications, equivalents and alternatives that fall within the sprit and scope of the various embodiments of the present disclosure. Regarding the drawings, like reference numerals refer to like elements.

The term “include,” “comprise,” “including,” or “comprising” used herein indicates disclosed functions, operations, or existence of elements but does not exclude other functions, operations or elements. It should be further understood that the term “include”, “comprise”, “have”, “including”, “comprising”, or “having” used herein specifies the presence of stated features, integers, steps, operations, elements, components, or combinations thereof but does not preclude the presence or addition of one or more other features, integers, steps, operations, elements, components, or combinations thereof.

The meaning of the term “or” used herein includes any combination of the words connected by the term “or”. For example, the expression “A or B” may indicate A, B, or both A and B.

The terms such as “first”, “second”, and the like used herein may refer to various elements of various embodiments, but do not limit the elements. For example, such terms do not limit the order and/or priority of the elements. Furthermore, such terms may be used to distinguish one element from another element. For example, “a first user device” and “a second user device” indicate different user devices. For instance, without departing the scope of the various embodiments of the present disclosure, a first element may be named as a second element, and similarly, a second element may be named as a first element.

It should be understood that when an element is referred to as being “connected” or “coupled” to another element, it can be directly connected or coupled to the other element or intervening elements may be present between the element and the other element. Alternatively, it should be understood when an element is referred to as being “directly connected” or “directly coupled” to another element, there are no intervening elements between the element and the other element.

The terminology used herein is not for delimiting the various embodiments of the present disclosure but for describing the specific embodiments. The terms of a singular form may include plural forms unless otherwise specified.

The terms used herein, including technical or scientific terms, have the same meanings as understood by those skilled in the art unless otherwise defined herein. The commonly used terms such as those defined in a dictionary should be interpreted in the same context according to the related art and should not be interpreted in an idealized or overly faunal sense unless otherwise defined explicitly.

Electronic devices according to the various embodiments of the present disclosure may have a communication function. For example, the electronic devices may include at least one of smartphones, tablet personal computers (PCs), mobile phones, video telephones, electronic book readers, desktop PCs, laptop PCs, network computers, personal digital assistants (PDAs), portable multimedia players (PMPs), MP3 players, mobile medical devices, cameras, wearable devices (e.g., head-mounted-devices (HMDs) such as electronic glasses), electronic apparel, electronic bracelets, electronic necklaces, electronic appcessories, electronic tattoos, and smart watches.

According to some embodiments, the electronic devices may be smart home appliances having a communication function. The smart home appliances may include at least one of, for example, TVs, DVD players, audios, refrigerators, air conditioners, cleaners, ovens, microwave ovens, washing machines, air cleaners, set-top boxes, TV boxes (e.g., Samsung HomeSync™, Apple TV™, or Google TV™), game consoles, electronic dictionaries, electronic keys, camcorders, and electronic picture frames.

According to some embodiments, the electronic devices may include at least one of medical devices (e.g., magnetic resonance angiography (MRA), magnetic resonance imaging (MRI), computed tomography (CT), scanners, and ultrasonic devices), navigation devices, global positioning system (GPS) receivers, event data recorders (EDRs), flight data recorders (FDRs), vehicle infotainment devices, electronic equipment for ship (e.g., navigation systems and gyrocompasses), avionics, security devices, head units for vehicles, industrial or home robots, automatic teller's machines (ATMs), and points of sales (POSs).

According to some embodiments, the electronic devices may include at least one of parts of furniture or buildings/structures having communication functions, electronic boards, electronic signature receiving devices, projectors, and measuring instruments (e.g., water meters, electricity meters, gas meters, and wave meters). The electronic devices according to the various embodiments of the present disclosure may be one or more combinations of the above-mentioned devices. Furthermore, the electronic devices according to the various embodiments of the present disclosure may be flexible devices. It would be obvious to those skilled in the art that the electronic devices according to the various embodiments of the present disclosure are not limited to the above-mentioned devices.

Hereinafter, the electronic devices according to the various embodiments will be described with reference to the accompanying drawings. The term “user” used herein may refer to a person who uses an electronic device or may refer to a device (e.g., an artificial electronic device) that uses an electronic device.

FIG. 1 illustrates a diagram showing an information providing system based on a movement state according to an embodiment.

Referring to FIG. 1, an information providing system 10 may include a vehicle 200 and an electronic device 100. Hereinafter, the vehicle 200 exemplifies a moving device for providing the mobility of the electronic device 100. However, in the various embodiments, the moving device for providing the mobility of the electronic device 100 is not limited to the vehicle 200. For example, the vehicle 200 may be substituted with various things capable of moving at not less than a specified speed, such as a motorcycle or a bicycle. For example, the vehicle 200 may represent a person, a horse or a ride that moves at a specified speed. Such a moving device may be various things capable of collecting movement-related state information and transferring the collected information to the electronic device 100.

The vehicle 200 may move at a specified speed in response to control by a driver. For example, the vehicle 200 may generate power using fuel, and may move on a road using the generated power. The vehicle 200 may include a vehicular electronic device 260. The vehicular electronic device 260 may include an on board diagnostics (OBD) module. The vehicular electronic device 260 may collect various information on movement (e.g., a moving speed, a moving direction or a moving distance). Furthermore, the vehicular electronic device 260 may collect information on a lane change. To this end, the vehicular electronic device 260 may include various sensors related to the collection of movement state information of the vehicle 200. For example, the vehicular electronic device 260 may include a vehicle speed sensor, a direction sensor or an acceleration sensor.

The vehicular electronic device 260 may transfer the collected information related to vehicle movement to the electronic device 100. To this end, the vehicular electronic device 260 may include a communication interface for communicating with the electronic device 100. For example, the vehicular electronic device 260 may establish a communication channel to the electronic device 100 through a wired communication interface. Alternatively, the vehicular electronic device 260 may establish a communication channel to the electronic device 100 through a wireless communication interface.

The vehicular electronic device 260 may include a display device. The vehicular electronic device 260 may output, through the display device, alarm information transferred by the electronic device 100. For example, the vehicular electronic device 260 may receive navigation information from the electronic device 100 and may display the navigation information on the display device. The vehicular electronic device 260 may receive a communication message from the electronic device 100 according to a movement state, and may output the communication message. The vehicular electronic device 260 may receive specific audio data from the electronic device 100 and may output the audio data. To this end, the vehicular electronic device 260 may include an audio output device.

The electronic device 100 may be arranged in the vehicle 200. The electronic device 100 may have a movement state according to the movement of the vehicle 200. According to an embodiment, the electronic device 100 may include at least one sensor for detecting the movement state. The electronic device 100 may collect information on whether the electronic device 100 is currently being moved using at least one sensor. While the electronic device 100 is moved, the electronic device 100 may collect moving speed information, moving direction information or moving distance information using at least one sensor. According to the various embodiments, the electronic device 100 may receive movement-related state infatuation from the vehicular electronic device 260. The received state information may be used as an information display criterion of the electronic device 100 (e.g., a criterion for determining whether to display information related to performance of a specific function of the electronic device 100).

According to an embodiment, an application related to the performance of a specific function may be installed in the electronic device 100. The electronic device 100 may output a screen according to the performance of the specific function. When outputting the screen, the electronic device 100 may reconfigure the screen according to the movement state information (e.g., moving speed information, moving direction information or moving distance information) so as to output the screen.

According to an embodiment, the electronic device 100 may receive a communication message (e.g., an SMS, an MMS, an IM or a traffic message). The electronic device 100 may limit or modify a notification related to the reception of the communication message into various foams according to the movement state. The electronic device 100 may output information on a non-notified communication message in a specific state (e.g., arriving at a destination, stopped state, or waiting for a signal). According to the various embodiments, the electronic device 100 may output specified guide information when receiving the communication message. If the movement state is changed while the guide information is output, the electronic device 100 may output the communication message. Furthermore, the electronic device 100 may change and output the guide information according to the change of the movement state.

According to an embodiment, when the change of the movement state (e.g., deceleration or stop) does not occur for a specified time, the electronic device 100 may suspend the output of the guide information. The electronic device 100 may store an unchecked communication message and may output the unchecked communication message in a specified state. For example, the electronic device 100 may provide a guide for accepting or rejecting the communication message or present guide information related to the movement, and may suspend the presenting of the guide information, change a presenting cycle or change a presenting form if the electronic device or an external device (e.g., the vehicular electronic device 260) moves at not less than a predetermined speed for a predetermined time.

According to the various embodiments, a method of differently providing information according to the movement state of an electronic device may also be applied when a user is walking or exercising (e.g., jogging or cycling). For example, when the user arrives at a specific location (e.g., a downtown area, a crosswalk, an intersection, an accident-prone area, a user's point of interest, or an appointed place) while moving, the electronic device 100 may differently control information provided to the user. According to an embodiment, the electronic device 100 may receive information on the specific location from an external device (e.g., the GPS, a server or a device installed in an adjacent place (e.g., a police station)). According to an embodiment, additionally or alternatively, the electronic device 100 may determine the information on the specific location on the basis of information pre-registered by the user (e.g., a point of danger or a schedule).

According to the various embodiments, the electronic device 100 may differently control an output of information (e.g., a communication message) on the basis of movement state-related information (a regional characteristic (e.g., a downtown, a mountain or a cycle lane) (calculable based on a positioning module arranged in the electronic device and map information pre-stored or provided by a server device), an altitude or a slope measured when a user exercises using, for example, a bicycle (a type of a moving device, which may be selected by a user from a menu provided by the electronic device or may be predetermined as default)) so as to provide the controlled information to the user.

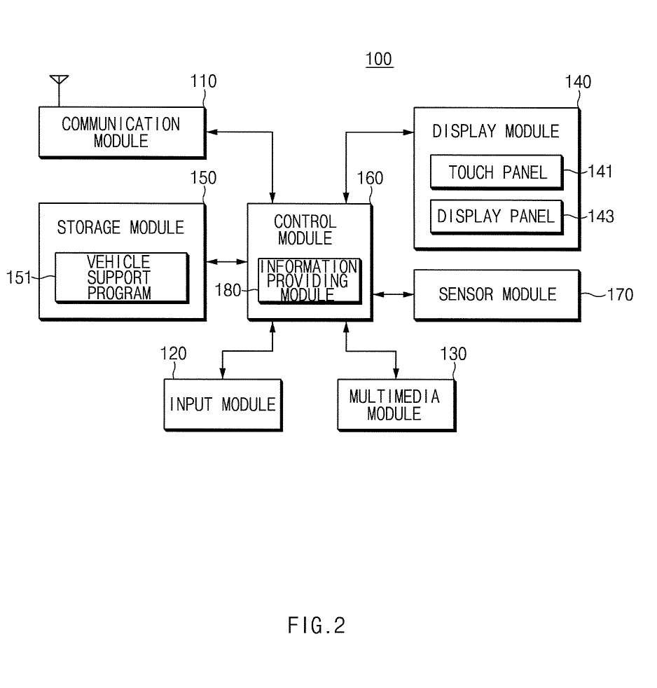

FIG. 2 illustrates a schematic block diagram showing an electronic device according to an embodiment.

Referring to FIG. 2, the electronic device 100 according to an embodiment may include a communication module 110, an input module 120, a multimedia module 130, a display module 140, a storage module 150, and a control unit 160 including an information providing module 180. According to the various embodiments, the electronic device 100 may further include a sensor module 170 used to collect state information based on movement.

The electronic device 100 may collect the state information on the basis of at least one of the communication module 110 and the sensor module 170. The control device 100 may control screen data to be output to the display module 140 on the basis of the collected state information. According to an embodiment, when the electronic device 100 is not moved, the electronic device 100 may output the screen data according to performance of a specific function. For example, when a moving speed of the electronic device 100 falls within a first speed range (e.g., 0 km/h (stop) or less than 60 km/h), the electronic device 100 may output a first user interface including a part of the screen data according to the performance of the specific function. For example, when the moving speed of the electronic device 100 falls within a second speed range (e.g., not less than 60 km/h), the electronic device 100 may output a second user interface obtained by modifying the screen data according to the performance of the specific function. The second user interface may be a user interface obtained by deleting (or changing) at least a part of information (or function) related to the first user interface. According to the various embodiments, when the electronic device 100 or an external device such as the vehicular electronic device 260 moves at a higher speed than that of a predetermined range, the control module 160 may refrain from outputting information related to a message. When the electronic device 100 or the external device (e.g., the vehicular electronic device 260) moves at a lower speed than that of the predetermined range, the control module 160 may establish a call channel in response to the message. According to the various embodiments, the electronic device 100 may additionally or alternatively provide three or more speed ranges besides the first and second speed ranges, and may provide different UIs corresponding to the speed ranges.

According to the various embodiments, the electronic device 100 may control an amount of screen data to be output according to a speed change. For example, the electronic device 100 may control the number of a plurality of objects included in the screen data according to the speed change. Alternatively, the electronic device 100 may change a shape of at least a part of the objects according to the speed change.

According to the various embodiments, when an event related to sleep mode entry occurs after a specific function is performed, the electronic device 100 may perform the function through background processing. In this operation, the electronic device 100 may output audio data generated by the background processing through the multimedia module 130. According to the various embodiments, when the electronic device 100 is moved while the display module 140 is turned on, the electronic device 100 may restrict operation of at least one of an input or output function of the display module 140 and an input function of the input module 120. According to the various embodiments, not only when the electronic device 100 is moved but also when another device (at least one of an electronic device and a moving device) is moved, operation of at least one of an input/output function of a display module included in an external device (e.g., the vehicular electronic device (260)) and an input function of an input module included in the external device may be restricted. Furthermore, when the movement of the electronic device 100 is stopped, at least one of the input or output function of the display module 140 and the input function of the input module 120 may be activated. On the basis of this operation, the electronic device 100 may be restricted from being operated while being moved (e.g., due to driving or walking) and may be operated when the movement is stopped. The above-mentioned operation may be provided as a mobility protection function so as to be installed in the electronic device 100. For example, the mobility protection function may be installed in the electronic device 100 via a server device by request from a user, or by a manufacturer of the electronic device 100 or according to a policy.

The communication module 110 may include at least one communication unit related to a communication function of the electronic device 100. For example, the communication module 110 may include various communication units including a mobile communication unit, a broadcast receiving unit such as a DMB module or a DVB-H module, a short-range communication unit such as a Bluetooth module, i.e. a ZigBee module or an NFC module or NEC module, or a Wi-Fi communication unit. According to an embodiment, the communication module 110 may receive, from another electronic device or a server device, a communication message (e.g., a text message, a multimedia message, a chatting message, an electronic mail, an application-related message, a notification message, or a voice or video call connection request message). Here, the notification message may include at least one of a message about a system, framework or platform of the electronic device 100 transmitted by a server device in a push-type manner, an advertisement or coupon message received at a specific period in relation to an installed specific application, or an update guide message.

According to an embodiment, the communication message received by the communication module 110 may be output or restricted from being output according to the movement state of the electronic device 100. Alternatively, a part of the communication message may be output according to the movement state of the electronic device 100. The communication message that has not been output or has been output partially may be automatically stored in response to control by the information providing module 180.

According to an embodiment, the communication module 110 may establish a communication channel to another electronic device when a connection input event occurs in response to the communication message related to a call connection. Alternatively, the communication module 110 may transmit a connection rejection message to the other electronic device when a rejection history event occurs in response to the communication message related to a call connection.

According to an embodiment, the electronic device 110 may receive, from a server device or another electronic device, situation information including information related to traffic congestion such as weather information and road condition information. The situation information received by the communication module 110 may be used to determine the movement state. For example, the communication module 110 may receive the weather information indicating rainy weather, snowy weather or foggy weather. Furthermore, the communication module 110 may receive the road condition information related to a road condition such as a curve or sharp curve, continuous curves or a straight course having at least a certain length. The weather information or the road condition information may be provided to the information providing module 180 so as to be used as conditions for controlling the screen data.

According to an embodiment, the input module 120 may generate an input signal of the electronic device 100. The input module 120 may include, for example, at least one of a keypad, a dome switch, a touchpad (resistive/capacitive type), a jog wheel, a jog switch, and a knob key (a physical key dedicated to a vehicle). The input module 120 may be implemented in the form of external buttons, wherein some buttons may be virtual buttons displayed on the display module. According to an embodiment, the input module 120 may include a plurality of keys for receiving number or text information and setting various functions.

The input module 120 may generate an input signal related to activation of an mobility support function of the electronic device 100, an input signal related to inactivation of the mobility support function, and an input signal related to activation of a specific function. The input module 120 may generate an input signal related to control of the specific function when the specific function is activated. According to an embodiment, when the specific function is activated while the mobility support function is performed, the input module 120 may be restricted from generating the input signal related to control of the specific function. For example, when a touch function is supported by the display module 140, the touch function of at least a part of a touch panel may be restricted according to the movement state information.

When a communication message related to a call connection is received, the input module 120 may generate an input signal indicting a call connection or an input signal indicating call rejection. The input module 120 may generate an input event related to communication message confirmation in response to output of a communication message reception notification. Each input signal may be provided to the control module 160 or the information providing module 180 so as to be converted to an instruction set in relation to performance of each function.

According to an embodiment, the multimedia module 130 may process an audio signal of the electronic device 100. For example, the multimedia module 130 may transfer the audio signal received from the control module 160 to a speaker. The multimedia module 130 may transfer an audio signal such as a voice received from a microphone to the control module 160. The multimedia module 130 may convert the audio signal such as the voice signal received from the microphone into a digital signal so as to transfer the digital signal to the control module 160.

According to an embodiment, the multimedia module 130 may output audio data according to a performance state of the mobility support function. When a specific function is performed and the screen data related to the specific function is controlled according to the movement state while the mobility support function is applying the electronic device, the multimedia module 130 may output guide information or an effect sound according thereto. The multimedia module 130 may output a guide sound or an effect sound corresponding to the reception of the communication message. According to an embodiment, when the communication message is received while the mobility support function is applied, the multimedia module 130 may restrict at least a part of the audio data output according to the movement state. For example, the multimedia module 130 may output volume-controlled audio data or may refrain from outputting the audio data according to the moving speed. Alternatively, with respect to content including a video signal and an audio signal, the multimedia signal 130 may output the audio signal alone according to the moving speed.

According to an embodiment, the display module 140 may output various screens corresponding to functions performed in the electronic device 100. For example, the display module 140 may output a standby screen, a menu screen or a lock screen. According to an embodiment, the display module 140 may output a navigation screen according to performance of a navigation function. The display module 140 may output a sound source playback screen, a playback control screen or a sound source information screen according to performance of a sound source playback function. The multimedia module 140 may output a communication message-related screen in response to the reception of the communication message.

According to an embodiment, the display module 140 may control screen data to be output according to the movement-related state information. For example, the display module 140 may exclude at least a part of a plurality of objects included in the screen data related to sound source playback so as to output a screen, while being moved. In the various embodiments, the display module 140 may modify at least a part of the plurality of objects into simplified information (e.g., at least one of modifying the sizes or number of previous objects, modifying color, modifying the number or directions of planes or lines included in a single object, substituting with a simplified specific object, and modifying or substituting the number of letters) and may output the simplified information. When the movement is stopped, the display module 140 may output a screen including all of the plurality of objects. In this operation, the display module 140 may differently output a screen according to a lapse of time after the movement is stopped. For example, the display module 140 may output a screen including a first number of objects from among the plurality of objects when a first time elapses after the movement is stopped. Furthermore, the display module 140 may output a screen including a second number (e.g., the first number<the second number) of objects from among the plurality of objects when a second time that is longer than the first time elapses after the movement is stopped.

According to an embodiment, the display module 140 may refrain from notifying the reception of a communication message, while being moved. According to the various embodiments, the display module 140 may exclude at least a part of the communication message so as to output a screen, while being moved. According to the various embodiments, the display module 140 may output guide information specified with respect to the communication message, while being moved. The guide information may include information on whether the communication message is received and behavior policy information related to checking the communication message. When the electronic device is stopped after being moved, the display module 140 may display at least a part of the communication message received while the electronic device was being moved. For example, when the movement is stopped, the display module 140 may display, at once, the communication message received while the electronic device was being moved.

The display module 140 may support, according to a rotation direction (or orientation) of the electronic device 100, screen display in a landscape mode, screen display in a portrait mode, and screen switching display depending on switching between the landscape mode and the portrait mode. The display module 140 may include at least one of a liquid crystal display (LCD), a thin film transistor LCD (TFT LCD), a light emitting diode (LED), an organic LED (OLED), an active matrix OLED (AMOLED), a flexible display, a bended display, and a 3D display. Some of the displays may be transparent or light transmissive displays.

Furthermore, the display module 140 may be provided with a touchscreen such that the display module 140 may be used as not only an output unit but also an input unit. The display module 140 may be configured such that a change in a pressure on a specific site of the display module 140 or a change in a capacitance of a specific site of the display module 140 is converted to an electric input signal. The display module 140 may be configured so as to detect not only a location and an area of a touch but also a pressure of the touch. The display module 140 may include a touch panel 141 and a display panel 143. The touch panel 141 may be placed on the display panel 143. The touch panel 141 may be an add-on type touch panel positioned on the display panel 143 or an on-cell type or in-cell type touch panel inserted into the display panel 143. The touch panel 142 transfers, to the control module 160, a user input responding to a gesture of a user. Here, the user input generated by a touching means such as a finger or a touch pen may include a touch, a multi touch, a tap, a double tap, a long tap, tap & touch, drag, flick, press, pinch in or pinch out. The user input may be defined in relation to setting or releasing of the mobility support function and checking of the communication message.

The display module 140 may further include a touch module related to operation of an electronic pen. For example, when the electronic pen is an electromagnetic induction-type pen, the display module 140 may further include an electromagnetic induction-type touch module. The display module 140 may provide, to the control module 160, a touch event that occurs on the couth panel 141 or the electromagnetic induction-type touch module.

According to an embodiment, an activation state of the touch panel 141 may be controlled according to the movement state. For example, when the movement is stopped, the entire region of the touch panel 141 may be defined as a valid touch region. While the electronic device is moved, at least a part of the entire region of the touch panel 141 may be defined as an invalid touch region. According to an embodiment, the size of the invalid touch region of the touch panel 141 may be controlled according to a moving speed. The invalid touch region defined due to the movement may be redefined as a valid touch region when the moving speed is decreased or the movement is stopped. The display panel 143 may output guide information about the invalid touch region of the touch panel 141. For example, while the electronic device 100 is moved, the display panel 143 may output information indicating that at least a part of the touch panel 141 is unable to receive an input. When the movement of the electronic device 100 is stopped, the display panel 143 may output information related to releasing of an available state of the touch panel 141.

According to an embodiment, the storage module 150 may store various programs and data related to processing and control of data related to operation of the electronic device 100. For example, the storage module 150 may store an operating system. According to an embodiment, the storage module 150 may include a vehicle support program 151. The vehicle support program 151 may include a routine (e.g., an instruction set, or a syntax and function related to the instruction set) related to setting or releasing of the mobility support function, a routine for collecting the movement-related state information, and a routine for processing a screen generated due to performance of a specific function according to a moving speed when the mobility support function is set. According to an embodiment, the vehicle support program 151 may include a routine for collecting communication messages, a routine for determining whether to output the collected communication messages on the basis of the state information, a routine for processing the communication messages when the communication messages are output, a routine for supporting output of guide information related to the communication messages, and a routine for storing the communication messages and then outputting the communication messages according to the state information.

The storage module 150 may include at least one of storage media such as a flash memory, a hard disk, a micro type memory, a card-type memory (e.g. a secure digital (SD) or extreme digital (XD) memory), a random access memory (RAM), a static RAM (SRAM), a read-only memory (ROM), a programmable ROM (PROM), an electrically erasable PROM (EEPROM), a magnetic RAM (MRAM), a magnetic disk, and an optical disk. The electronic device 100 may be operated in association with a web storage for performing a storage function of the storage module 150 on the internet.

The electronic device 100 may further include the sensor module 170. Here, the sensor module 170 may include at least one of an illuminance sensor, a gesture sensor, a proximity sensor, a gyro sensor, an atmospheric pressure sensor, a magnetic sensor, an acceleration sensor, a grip sensor, an RGB (red, green, blue) sensor, a biometric sensor, a temperature/humidity sensor, an ultraviolet (UV) sensor, a hall sensor, and a steering sensor. The sensor module 170 may measure physical quantity or detect an operation state of the electronic device 100 so as to convert measured or detected information into an electric signal. The sensor module 170 may further include a humidity sensor. Furthermore, the sensor module 170 may further include a control circuit for controlling at least one sensor included therein. For example, the electronic device 100 may detect whether the electronic device 100 is moved and detect a moving speed thereof using the acceleration sensor. The electronic device 100 may detect moving direction information of the electronic device 100 using the steering sensor. The electronic device 100 may detect a moving pattern of the electronic device 100 using the gyro sensor and the acceleration sensor. The electronic device 100 may detect situation information about an external environment of the electronic device 100 using the humidity sensor. The information collected by the sensor module 170 may be provided to the control module 160 so as to be used as state information related to performance of a specific function or processing of the communication message.

According to the various embodiments, the electronic device 100 may further include a camera module (not illustrated). The camera module may collect image information about an peripheral situation of the electronic device 100. The electronic device 100 may support a function related to processing of the communication message on the basis of the image information collected by the camera module. For example, while the electronic device 100 is not moved, the electronic device 100 may automatically enable the camera module so as to collect the image information. In this operation, the electronic device 100 may output a received communication message. The electronic device 100 may analyze the image information collected by the camera module so as to determine whether a traffic light is changed. The electronic device 100 may suspend the outputting of the communication message when the traffic light is changed.

The control module 160 may process and transfer data related to operation of the electronic device 100 and may process and transfer control signals. According to an embodiment, when the mobility support function is performed, the control module 160 may employ the information providing module 180 in relation to processing of screen data due to performance of a specific function and processing of a communication message.

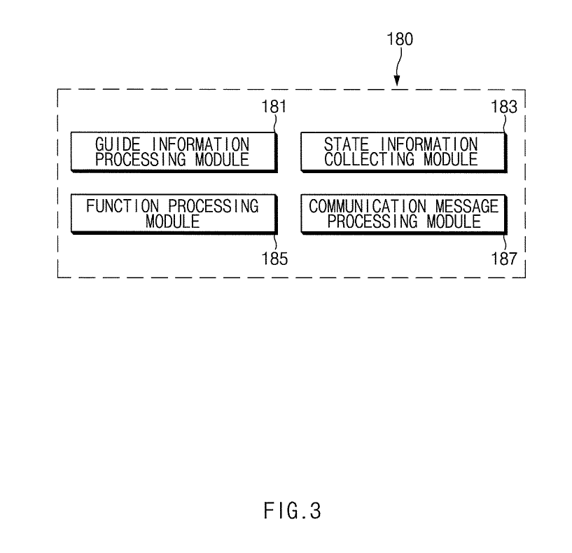

FIG. 3 illustrates a diagram showing the information providing module 180 according to an embodiment.

Referring to FIG. 3, the information providing module 180 may include a guide information processing module 181, a state information collecting module 183, a function processing module 185, and a communication message processing module 187. Any of the modules may be implemented as part of a controller or processor.

The guide information processing module 181 may process an output of guide information related to the mobility support function. According to an embodiment, the guide information processing module 181 may output the guide information related to setting or releasing of the mobility support function. For example, when the mobility support function is set, the guide information processing module 181 may allow a message for providing guidance for setting the mobility support function or an indicator related to setting of the mobility support function to be output to the display module 140. According to the various embodiments, the guide information processing module 181 may provide specific guide information related to a communication message to a user by means of sound or screen output. For example, when the communication message is received, the guide information processing module 181 may output guide information such as “Reduce speed please”. For another example, when the communication message is received, the guide information processing module 181 may output guide information such as “Please pull over to check message”. Even after a specific time elapses after the guide information related to the communication message is output, the guide information processing module 181 may suspend the outputting of the guide information if the electronic device is being moved. Alternatively, after a lapse of a specific time, the guide information processing module 181 may output guide information such as “Communication message is stored”.

According to the various embodiments, the guide information processing module 181 may output the guide information related to control of performance of a specific function. For example, the guide information processing module 181 may output the guide information related to restriction of an input function if the electronic device 100 is moved while the specific function is performed. The guide information processing module 181 may output the guide information related to releasing of the input function restriction if the movement is stopped while the specific function is performed. The guide information processing module 181 may output various guide information according to the moving speed of the electronic device while the specific function is performed. For example, the guide information processing module 181 may output the guide information for restricting a part of the input function when the electronic device is moved at a first speed. The guide information processing module 181 may output the guide information related to unavailability of the input function when the electronic device is moved at a second speed. The guide information processing module 181 may output the guide information indicating that a function that is being performed may be terminated when the electronic device is moved at a third speed.

The state information collecting module 183 may collect the state information related to the movement of the electronic device. According to an embodiment, the state information collecting module 183 may collect information on a moving speed, moving direction or moving distance using at least one sensor included in the electronic device 100. According to the various embodiments, the state information collecting module 183 may communicate with the vehicle 200 so as to collect movement-related state information collected by the vehicle 200. For example, the state information collecting module 183 may collect, from the vehicle 200, state information such as a moving speed, a moving direction, a moving distance or a lane change. According to the various embodiments, the state information collecting module 183 may collect the state information related to a movement situation. For example, the state information collecting module 183 may collect humidity information collected by at least one humidity sensor arranged in the electronic device and the vehicle 200, information on a temperature inside or outside the vehicle 200 collected on the basis of a temperature sensor, illuminance information collected on the basis of an illuminance sensor, or noise information collected on the basis of a microphone. According to the various embodiments, the state information collecting module 183 may collect the state information related to a peripheral situation. For example, the state information collecting module 183 may collect weather information of a current location, weather information of each region, and traffic situation information.

In relation to the collection of weather information, the state information collecting module 183 may access a server device that provides weather information. Furthermore, the state information collecting module 183 may access a server device of a traffic condition control center that provides traffic condition information, so as to collect information. The weather information may include information on rain, snow, fog or ice formation. The road condition information may include information on a curved or straight section, accident occurrence information, or information on a section where driving is dangerous or where cautious driving is required. Specific weights may be respectively applied to the weather information and the road condition information so as to calculate a degree of traffic congestion. For example, the state information collecting module 183 may assign different grades to rain, snow, fog and road icing. Furthermore, the state information collecting module 183 may assign different grades to a degree of curve, the number of continuous curves within a specific section, a length of a straight section, a region where accidents have occurred or where caution is required, and a children protection zone in the road condition information. The state information collecting module 183 may calculate the degree of traffic congestion on the basis of at least one of the above-mentioned pieces of information.

The function processing module 185 may receive the movement-related state information from the state information collecting module 183, and may control, on the basis of the movement-related state information, the display module 140 and the input module 120 in relation to performance of a specific function. For example, when movement occurs while the specific function is performed, the function processing module 185 may turn off the display module 140 or may allow the display module 140 to output only some of objects included in screen data. When the movement is stopped or changed, the function processing module 185 may accordingly change the output of the screen data.

According to the various embodiments, the function processing module 185 may enable or disable a control button in relation to control of performance of a specific function. Here, the control button may include at least one of a key button included in the input module 120 or a virtual key button based on the display module 140. According to the various embodiments, the function processing module 185 may temporarily suspend or terminate the performance of the specific function according to state information. In the various embodiments, the function processing module 185 may reactivate the specific function temporarily suspended or terminated according to the state information. According to the various embodiments, the function processing module 185 may differently control at least one of virtual key buttons of the display module 140 and at least one of key buttons of the input module 120, inactivated according to the state information, individually or collectively.

The communication message processing module 187 may perform at least one of receiving, outputting and storing a communication message. For example, the communication message processing module 187 may activate the communication module 110 and may allow the communication module 110 to maintain a standby state. The communication message processing module 187 may ignore occurrence of an input event related to operation of the communication module 110 while the electronic device is moved. The communication message processing module 187 may request the guide information processing module 181 to output guide information related to unavailability of a communication function while the electronic device is moved.

According to the various embodiments, the communication message processing module 187 may receive a communication message including a text or an image and may determine whether to output the received communication message according to the movement-related state information. For example, the communication message processing module 187 may allow the received communication message to be output when the vehicle 200 is stopped or the movement of the electronic device 100 is stopped. The communication processing module 187 may output a part of the communication message or may restrict the output of the communication message according to a type of the state information, while the vehicle 200 or the electronic device 100 is moved. For example, when the electronic device is moved at a first speed (e.g., stop or a low speed such as less than 20 km/h, 30 km/h or 60 km/h), the communication message processing module 187 may output only communication message sender information to one side of the display module 140 or in the form of a voice signal. When the electronic device is moved at a second speed (e.g., the second speed>the first speed), the communication message processing module 187 may suspend the outputting of the communication message and may request the guide information processing module 181 to output determined guide information related to the movement of the electronic device 100.

According to the various embodiments, the communication message processing module 187 may receive a call-related message. The communication message processing module 187 may request the guide information processing module 181 to output guide information for inducing a stop if the electronic device is being moved when the call-related message is received. When the movement of the vehicle 200 or the electronic device 100 is stopped, the communication message processing module 187 may allow screen data related to a call connection to be output to the display module 140.

According to the various embodiments, the communication message processing module 187 may automatically store a communication message without outputting the communication message upon receiving the communication message, while the electronic device is moved. In this operation, the communication message processing module 187 may restrict notification of the communication message. When the movement of the vehicle 200 or the electronic device 100 is stopped, the communication message processing module 187 may allow the stored communication message to be output. According to the various embodiments, the communication message processing module 187 may output a communication message reception notification when the number of received communication messages is at least a predetermined number. Alternatively, when a call connection request is received at least a predetermined number of times from another electronic device of the same type as the electronic device, the communication message processing module 187 may notify the reception of the call connection requests.

According to the various embodiments, the communication message processing module 187 may output a plurality of stored communication messages according to a predetermined rule. For example, when a call connection request message, a text message, a multimedia message, a chatting message, an electronic mail or the like is received, the communication message processing module 187 may arrange the call connection request message at the top of a list and may arrange the chatting message at the bottom of the list so as to output the messages. Alternatively, the communication message processing module 187 may arrange a most recently received message at the top of the list and may arrange the other messages on the basis of a message reception time.

According to the various embodiments, the electronic device 100 may include a memory for storing information related to movement of the electronic device or an external device (e.g., a vehicular electronic device) for the electronic device and an information providing module functionally connected to the memory, wherein the information providing module may be configured to differently control, on the basis of the information, a function of an input device or output device of the electronic device or the external device, an application to be executed in the electronic device or the external device, or at least a part of a function of the application with respect to a message received by the electronic device.

According to the various embodiments, the information may include at least one of a moving speed, a moving direction, a moving distance, a moving route, on-board diagnostics (OBD) information, weather condition information and road condition information of the electronic device or the external device.

According to the various embodiments, the information providing module may be configured to delete or modify at least a part of data currently displayed or to be displayed on the output device in response to the message.

According to the various embodiments, the information providing module may be configured to provide a first user interface through the electronic device or the external device when a speed of the movement falls within a first speed range, and provide a second user interface obtained by deleting or modifying at least a part of information or function related to the first user interface through the electronic device or the external device when the speed of the movement falls within a second speed range.

According to the various embodiments, the information providing module may be configured to refrain from outputting information related to the message when the speed of the movement falls within a predetermined speed range, and output the information related to the message when the speed of the movement does not fall within the predetermined speed range.

According to the various embodiments, the information providing module may be configured to receive traffic information obtained by at least one camera functionally connected to the electronic device or the external device as the information.

According to the various embodiments, the information providing module may be configured to present, on the basis of the information, guide information related to the movement with respect to the message.

According to the various embodiments, the information providing module may be configured to suspend the presenting of the guide information or change a presenting period when the electronic device or the external device is moved for at least a predetermined time or moved at a higher speed than a predetermined speed.

According to the various embodiments, the information providing module may be configured such that the predetermined time or the predetermined speed starts to be measured from the time at which the guide information is presented.

As described above, the electronic device 100 according to an embodiment may include at least one of the sensor module 170 for collecting movement-related state information and the communication module 110 for receiving the movement-related state information from a moving device, the information providing module 180 or the control module 160 for restricting outputting of at least a part of screen data and restricting generation of at least a part of an input event according to the movement-related state information, and the display module 140 and the input module 120 for outputting the screen data and for generating the input event.

According to the various embodiments, at least one of the sensor module 170 and the communication module 110 may be configured to select at least one of a moving speed, a moving direction, a moving distance, a moving route and on-board diagnostics (OBD) information of the electronic device 100, information on a weather condition outside the electronic device 100, and information on conditions of a road on which the electronic device 100 is moved.

According to the various embodiments, the display module 140 may be configured to display objects included in screen data related to performance of a specific function after removing at least a part of the objects, or display the objects as modified objects by modifying at least a part of the objects, or display the objects as modified objects by removing at least a part of the objects and modifying the remaining objects.

According to the various embodiments, the display module 140 may be configured to restore the removed object to output the screen data according to a change of the movement-related state information, or restore the modified object to output the screen data according to the change of the movement-related state information.

According to the various embodiments, the information providing module 180 may be provided as an independent hardware module separate from the control module. Alternatively, the information providing module 180 may be provided as a hardware module or a software module arranged in the control module 160.

According to the various embodiments, at least one of the control module 160 and the information providing module 180 may be configured to disable the virtual key buttons of the display module 140 or the key buttons of the input module 120.

According to the various embodiments, at least one of the control module 160 and the information providing module 180 may be configured to disable at least one of the virtual key buttons or at least one of the key buttons according to a moving speed.

According to the various embodiments, at least one of the control module 160 and the information providing module 180 may be configured to enable the disabled virtual key buttons of the display module 140 and the disabled key buttons of the input module 120 according to the change of the movement-related state information.

According to the various embodiments, the communication module 110 may be configured to receive a communication message including at least one of a one-time message including at least a part of a text and an image (e.g., a message transmitted through a unidirectional channel from one electronic device to another electronic device, such as a text message or a chatting message) and a call-connection-type message (e.g., a message transmitted unidirectionally or bidirectionally on the basis of a communication channel maintained between one electronic device and another electronic device, such as a voice call, a video call or data transmission/reception).

According to the various embodiments, at least one of the control module 160 and the information providing module 180 may be configured to refrain from outputting the one-time message according to the movement-related state information when the electronic device is moved at a specific speed or higher.

According to the various embodiments, at least one of the control module 160 and the information providing module 180 may be configured to provide a guide for receiving the communication message or output predetermined guide information when the communication message that the control module 160 or the information providing module 180 refrains from outputting is accumulated as much as at least a specific number.

According to the various embodiments, at least one of the control module 160 and the information providing module 180 may be configured to provide a guide for receiving a communication message or output predetermined guide information when the communication message is received from a set another electronic device.

According to the various embodiments, the electronic device 100 may further include the storage module 150 for storing the communication message, and the control module 160 or the information providing module 180 may be configured to output the stored communication message according to the movement-related state information when the electronic device is stopped or moved at a specific speed or lower.

According to the various embodiments, at least one of the control module 160 and the information providing module 180 may be configured to suspend the outputting of the communication message when the movement-stopped state is changed.

According to the various embodiments, the electronic device 100 may further include a camera module for collecting traffic light information, and at least one of the control module 160 and the information providing module 180 may be configured to suspend the outputting of the communication message according to a change of the signal light information.

According to the various embodiments, the display module 140 may be configured to output a screen related to reception of the call-connection-type message according to the movement-related state information when the electronic device is stopped or moved at a specific speed or lower, and the communication module 110 may be configured to establish a communication channel according to a call connection input event.

According to the various embodiments, at least one of the control module 160 and the information providing module 180 may be configured to automatically release the communication channel according to the movement-related state information when the electronic device is moved.

According to the various embodiments, the display module 140 may be configured to output predetermined guide information related to movement when the communication message is received.

According to the various embodiments, the display module 140 may be configured to suspend the outputting of the guide information when the electronic device is moved at a specific speed or higher after a lapse of a specific time after outputting the predetermined guide information.

According to the various embodiments, the display module 140 may be configured to output the communication message when the electronic device is moved at a specific speed or lower or is stopped after outputting the predetermined guide information.

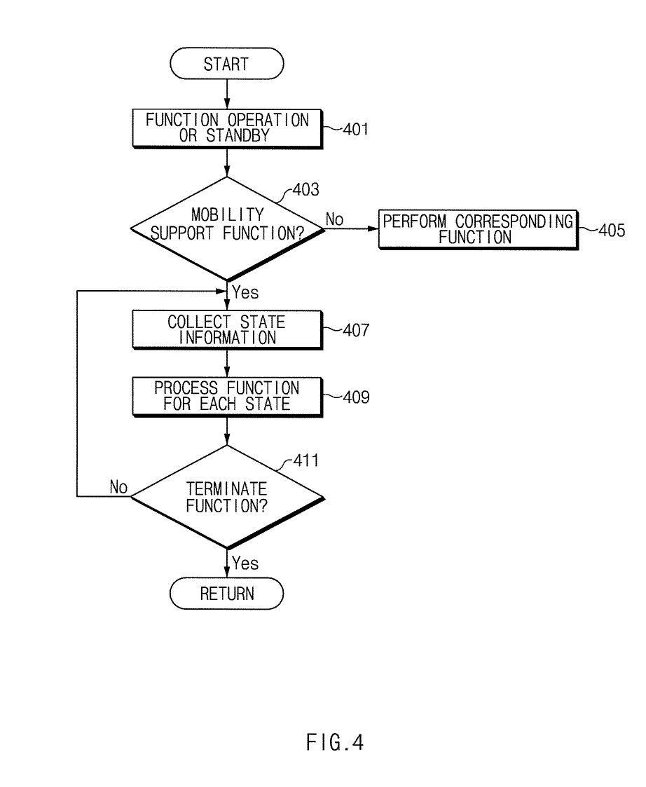

FIG. 4 illustrates an information providing process based on a movement state of an electronic device according to an embodiment.

Referring to FIG. 4, in operation 401, the electronic device 100 (e.g., the control module 160 or the information providing module 180, hereinafter described as the information providing module 180) may perform specific function operation or function holding according to at least one of set schedule information and user control. According to an embodiment, in relation to the function operation or the function holding, the information providing module 180 may perform a specific function according to a set schedule or an input event. For example, the information providing module 180 may receive the input event for performing a sound source playback function, a broadcast receiving function, a web access function, a gallery function, or a navigation function to perform a corresponding function. The information providing module 180 may have a sleep state (where the display module 140 is turned off). The information providing module 180 may output a standby screen or a specific menu screen.

In operation 403, for example, the information providing module 180 may check whether an event related to the mobility support function occurs. For example, the information providing module 180 may check whether there is a setting related to performance of the mobility support function or an input event related to the mobility support function occurs. If there is no setting related to performance of the mobility support function or the input event related to the mobility support function does not occur, the process may proceed to operation 405 such that a specific function related to the input invent is performed or performance of a previous function is maintained.

If the event related to the mobility support function occurs in operation 403, for example, the information providing module 180 may collect state information in operation 407. For example, the information providing module 180 may collect the movement-related state information using at least one sensor included in the sensor module 170. For example, as described above, the state information may include a moving speed, a moving direction, a moving distance, ambient weather information and road condition information of the electronic device 100 arranged in the vehicle 200. According to the various embodiments, the information providing module 180 may control the communication module 110 so as to establish a communication channel to an external device (e.g., the vehicular electronic device 260). The information providing module 180 may receive state information collected by the vehicular electronic device 260.

In operation 409, the information providing module 180 may process a function for each state using the collected state information. For example, the information providing module 180 may output screen data related to a function that is being performed, according to whether the vehicle is currently moved or stopped. The information providing module 180 may differently output at least a part of the screen data according to a moving speed. The information providing module 180 may differently output at least a part of the screen data according to the degree of traffic congestion. The degree of traffic congestion may be differently calculated on the basis of at least one of a curve shape of a road, the number of curves, accident occurrence history, conditions such as fog, rain, snow or ice forming, a traffic density, a vehicle moving speed, the periphery of a residential area, and a children protection zone. The above-mentioned information may be received from a traffic information providing center or may be obtained from map information stored in the storage module 150, as described above.

According to an embodiment, the display module 180 may output screen data related to a function that is being performed according to state information without additionally processing the screen data. Alternatively, the information providing module 180 may remove at least a part of objects included in the screen data related to the function that is being performed according to the state information, and may output the screen data including the remaining objects. Alternatively, the information providing module 180 may modify at least a part of the objects included in the screen data related to the function that is being performed according to the state information into a simplified image or text, and may output the modified object. The modified object may be an object obtained by removing or modifying at least a part of a screen element (e.g., at least a part of color, a line or a plane) or a text included in a specific object.

In operation 411, the information providing module 180 may check whether an input event related to function termination occurs. When the event related to function termination occurs, for example, the information providing module 180 may terminate the mobility support function, and the process may return to operation 401. If the event related to function termination does not occur, for example, the process may return to operation 407 such that the information providing module 180 re-performs operation 407 and the following operations.

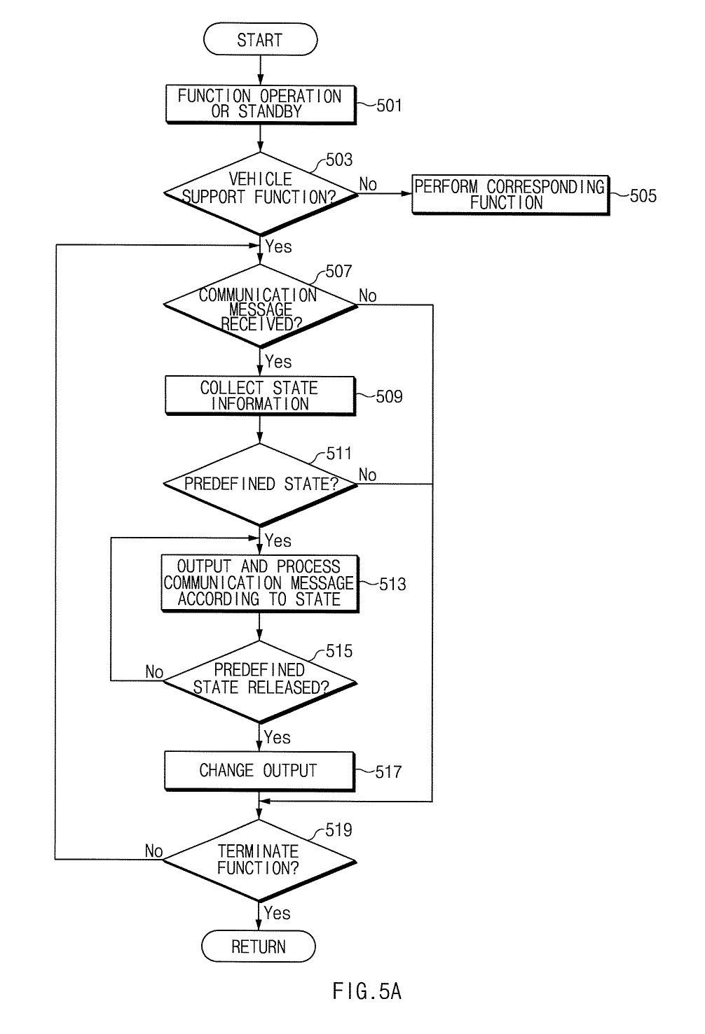

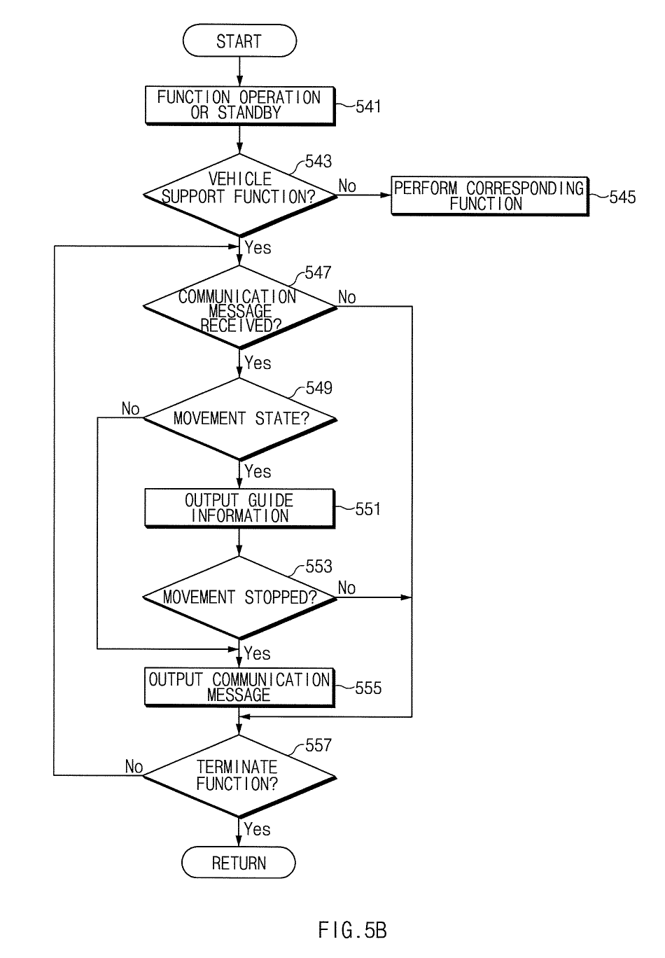

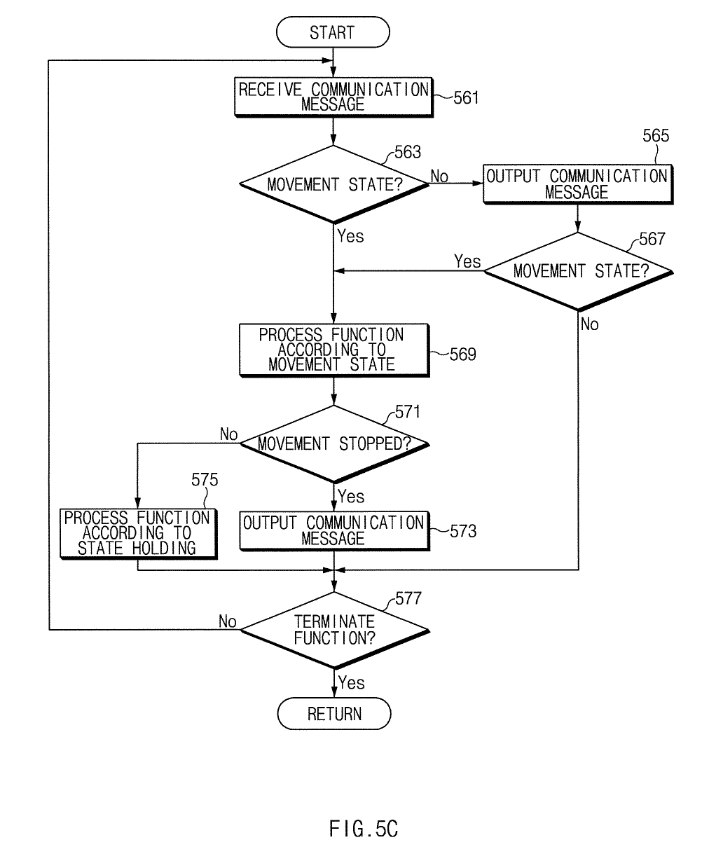

FIG. 5a illustrates a process for providing information based on a movement state in relation to a communication message according to an embodiment. The method for providing information related to the communication message of 5a may be a communication-message-related operation method of the state-information-based electronic device of FIG. 4.

Referring to FIG. 5a, in operation 501, the electronic device 100 (e.g., the control module 160 or the information providing module 180, hereinafter described on the basis of the information providing module 180) may perform specific function operation or function holding according to at least one of set schedule information and user control. For example, the information providing module 180 may enable the communication module 110 in relation to communication function support in an operation related to the function operation or function holding of the electronic device 100. Furthermore, the information providing module 180 may perform various functions according an input event, such as a sound source playback function, a navigation function, a game function, a broadcast receiving function, and a stream receiving function.

According to an embodiment, in operation 503, the information providing module 180 may determine whether a mobility support function setting exists or an event related to performance of the mobility support function occurs. In this operation, if there is no mobility support function setting or the event does not occur, the information providing module 180 may perform a previous function or a function corresponding to occurrence of a specific event, in operation 505.

When application of the mobility support function is requested, the information providing module 180 may check whether a communication message is received in operation 507. Here, the communication message may include a first-type message, e.g., a one-time message, including a text or an image, such as a text message, a multimedia message, a chatting message and an electronic mail, and a second-type message requiring a call connection, e.g., a connection request-type message. In operation 509, the information providing module 180 may collect state information on the basis of a received communication message. Operation 509 for collecting the state information may be performed prior to operation 507 for checking whether the communication message is received. As described above, the state information may include at least one of the movement-related information collected using at least one sensor or communication module 110 included in the sensor module 170 of the electronic device 100 and the movement-related information collected by the vehicular electronic device 260 of the vehicle 200.

In operation 511, the information providing module 180 may check whether the electronic device 100 is in a specified state, e.g., a movement-stopped state, on the basis of the collected state information. Here, the specified state may be a state in which the electronic device 100 is not moved or a state in which the electronic device 100 is moved at a specific speed or lower (e.g., less than 20 km/h, 30 km/h or 60 km/h). Alternatively, the specified state may include a state in which a total sum of various elements is not greater than a specific value, e.g., a state in which the degree of traffic congestion is not greater than a specific value, e.g., at least one of a state in which a road is straight without a curve, a state in which there is no fog and a state in which a traffic density is not greater than a specific value.

When the state determined on the basis of the state information related to the movement of the electronic device 100 is a specified state, e.g., a movement-stopped state (e.g., at least one of a state in which a moving speed is 0 and a state in which the moving speed is lower than a predetermined speed), the information providing module 180 may output and process the communication message according to the state, in operation 513. According to an embodiment, when the received communication message is a one-time message (e.g., a unidirectional message such as a text message, an electronic mail or a chatting message), the information providing module 180 may output the received communication message to the display module 140. According to the various embodiments, when the received communication message is a connection request-type message (e.g., a message for requesting a communication channel connection), the information providing module 180 may control the received communication message by outputting the received communication message to the display module 140, outputting a reception notification or automatically storing.

In operation 515, for example, the information providing module 180 may determine whether the electronic device is in a state of being moved (e.g., at least one of a state in which a moving speed is not 0 and a state in which the moving speed is at least a specific speed). If the electronic device is not in the state of being moved, the process may skip operation 517 and may proceed to operation 519. When the electronic device 100 is moved at a specific speed or higher, the information providing module 180 may change an output in operation 517. For example, the information providing module 180 may automatically suspend outputting of a communication message. Accordingly, the information providing module 180 may allow a screen output before outputting the communication message, e.g., a navigation screen, to be output. According to the various embodiments, the information providing module 180 may automatically release a call connection if the electronic device is in a call connection state. In this operation, the information providing module 180 may output guide information indicating that the call connection may be broken if the electronic device 100 is moved or the moving speed of the electronic device 100 is at least a specific speed.

According to an embodiment, in operation 519, the information providing module 180 may check whether an event related to function termination occurs. If the event related to function termination does not occur, the process may return to operation 507 such that the information providing module 180 re-performs operation 507 and the following operations. If the event related to function termination occurs, the information providing module 180 may terminate the mobility support function. When the mobility support function is terminated, the information providing module 180 may perform at least one of returning to a state prior to performance of the mobility support function, switching to a sleep mode and switching to a function or a screen set by a user.

FIG. 5b illustrates a process for providing information based on a movement state using guide information according to the various embodiments. The method for providing information related to the communication message of 5b may be a communication-message-related operation method of the state-information-based electronic device of FIG. 4.

Referring to FIG. 5b, in operation 541, the control module 160 or the information providing module 180 of the electronic device 100 (hereinafter description is provided on the basis of the information providing module 180) may perform specific function operation or function holding (e.g., a sound source playback function, supporting a sleep mode state, or outputting a lock screen) according to at least one of set schedule information and user control. In operation 543, the information providing module 180 may determine whether a mobility support function setting exists or an event related to performance of the mobility support function occurs. If it is determined that the event related to the mobility support function does not occur in operation 543, the information providing module 180 may control performance of a function corresponding to the type of the event, in operation 545. When application of the mobility support function is requested in operation 543, the information providing module 180 may check whether a communication message is received in operation 547. Above-mentioned operations 541, 543, 545 and 547 may be similar to operations 501, 503, 505 and 507 described above with reference to FIG. 5a.

On the basis of the communication message received in operation 547, the information providing module 180 may check whether the electronic device is in a state of being moved, in operation 549. If it is determined that the electronic device is in the state of being moved, the information providing module 180 may output guide information, in operation 551. For example, if the electronic device 100 is being moved, the information providing module 180 may output the guide information for inducing a user to stop the movement or adjust a moving speed to a specific speed or lower in relation to checking of the communication message. Here, the operation 551 may be omitted according to design modification or user setting modification.

In operation 553, the information providing module 180 may check whether the movement of the electronic device 100 is stopped. According to an embodiment, if it is determined that the electronic device 100 is not moved in operation 553, the information providing module 180 may allow a received communication message to be output in operation 555. If it is determined that the electronic device is not in the state of being moved, i.e. the movement of the electronic device is stopped in operation 549, operations 551 and 553 may be skipped and the process may proceed to operation 555.

According to an embodiment, in operation 557, the information providing module 180 may check whether an event related to function termination occurs. If it is determined that the event related to function termination does not occur in operation 557, the process may return to operation 547 such that the information providing module 180 re-performs operation 547 and the following operations. If it is determined that the event related to function termination occurs in operation 557, the process may return to operation 541 such that the information providing module 180 re-performs operation 541 and the following operations.

According to the various embodiments, the information providing module 180 may restrict an input function while outputting guide information. For example, the information providing module 180 may restrict or suspend operation of at least one of an input/output function of the display module and an input function of the input module while outputting guide information for inducing a user to reduce a moving speed to a specific speed or lower or stop the movement.

FIG. 5c illustrates a process for providing information based on a movement state according to the various embodiments. The method for providing information related to the communication message of 5c may be a communication-message-related operation method of the state-information-based electronic device of FIG. 4.

Referring to FIG. 5c, in operation 561, the control module 160 or the information providing module 180 of the electronic device 100 (hereinafter description is provided on the basis of the information providing module 180) may control reception of a communication message (e.g., an SMS, an MMS, an IM, a traffic message, or a message for requesting connection of at least one of a voice call and a video call). In at least one of a state prior to the reception of the communication message and a state after the reception of the communication message, the information providing module 180 may perform at least one of an operation of collecting sensor information related to whether the electronic device is moved and an operation of state information related to reception of a mobility-related notification message.

In operation 563, the information providing module 180 may determine whether the electronic device is moved on the basis of the collected (or received) information. If it is determined that the electronic device is not moved or the movement of the electronic device is stopped in operation 563, the information providing module 180 may output a received communication message (e.g., outputting at least one of a call connection request screen, a text message output screen, a multimedia message output screen and a chatting message reception screen). If the movement is not stopped after a function is performed according to a movement state, the information providing module 180 may process a function according to maintenance of a state. For example, when a predetermined time elapses while guide information is output, the information providing module 180 may suspend the outputting of the guide information.

Additionally or alternatively, in operation 567, the information providing module 180 may check whether the movement of the electronic device occurs (e.g., at least one of determining whether the movement occurs by analyzing a signal by a sensor activated to detect the movement and determining whether the movement occurs on the basis of a movement-related notification message received from another electronic device). If it is determined that the movement occurs in operation 567, the information providing module 180 may process a function according to the movement. For example, while the communication message is output, the information providing module 180 may suspend the outputting of the communication message in response to the movement. Alternatively, the information providing module 180 may output guide information (e.g., outputting information for inducing a user to stop the movement in relation to checking of a message) or may modify an object on a screen. When the movement occurs while a call connection is performed, the information providing module 180 may automatically terminate the call connection. In this operation, the information providing module 180 may provide a guide indicating that the call connection may be automatically terminated after a lapse of a predetermined time. Additionally or alternatively, the information providing module 180 may restrict an input function such that a call connection attempt is not allowed while the electronic device is moved. If it is determined that the movement does not occur in operation 567, the process may proceed to operation 577. According to the various embodiments, if it is determined that the movement currently occurs in operation 563, the information providing module 180 may process a function according to a movement state as described above, in operation 569.

In operation 571, the information providing module 180 may check whether the movement is stopped. When the movement is stopped, the information providing module 180 may output the communication message in operation 573. If the movement is not stopped, the information providing module 180 may process a function in response to the maintenance of the movement state (e.g., at least one of outputting guide information and outputting screen information in a different manner from that for a movement-stopped state), in operation 575. In operation 577, the information providing module 180 may check whether an event related to termination of outputting of the communication message occurs. If the event related to function termination does not occur, the process may return to operation 561 such that the information providing module 180 re-performs operation 561 and the following operations. When the event related to function termination occurs, the information providing module 180 may terminate a communication message output function based on a movement state, and may control performance of a function according to set schedule information or a user input. When a default option is to perform the communication message output function based on the movement state, operation 577 may be omitted.

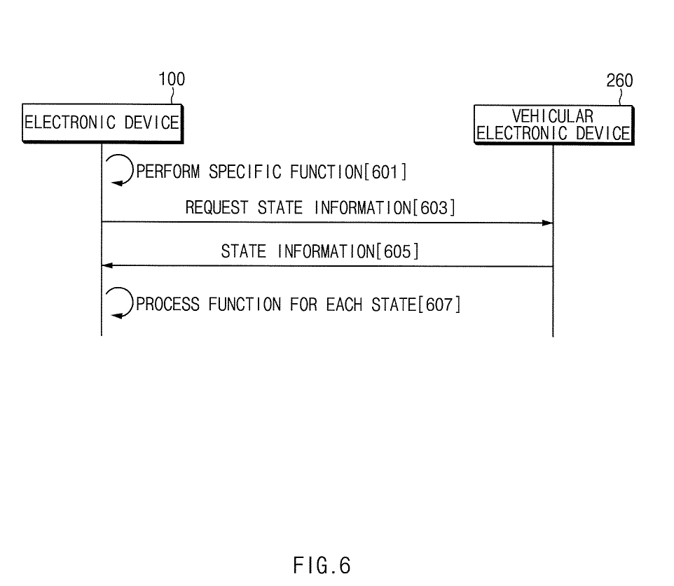

FIG. 6 illustrates a process for operating a system based on a movement state according to an embodiment.

Referring to FIG. 6, in operation 601, the electronic device 100 may perform a specific function. For example, the electronic device 100 may output a standby screen or a menu screen. Alternatively, the electronic device 100 may perform a video function or a broadcast receiving function according to an input event. According to an embodiment, in operation 603, the electronic device 100 may request the state information from the vehicular electronic device 260 when the mobility support function is applied. To this end, the electronic device 100 may establish a communication channel to the vehicular electronic device 260. For example, the electronic device 100 may establish various communication channels for transmitting/receiving the state information, such as a Bluetooth communication channel, a wireless fidelity (Wi-Fi) direction communication channel or a controller area network (CAN) communication channel.

The vehicular electronic device 260 may collect the state information in response to the state information request from the electronic device 100. The vehicular electronic device 260 may accumulate and store the state information in an ignition-started state. In operation 607, the vehicular electronic device 260 may transmit the collected information to the electronic device 100. Here, the vehicular electronic device 260 may transmit the state information obtained at the time at which the state information request was received or the accumulated state information.

According to an embodiment, upon receiving the state information from the vehicular electronic device 260, the electronic device 100 may process a function for each state on the basis of the received state information. For example, the electronic device 100 may exclude at least a part of screen data related to a specific function that is being performed so as to output the screen data to the display module 140. According to the various embodiments, the electronic device 100 may suspend the outputting of the screen data, or may modify some objects in the screen data so as to output modified objects to the display module 140.

According to the various embodiments, the vehicular electronic device 260 (such as a navigation device arranged in a vehicle) may receive the state information from an OBD of a vehicle. In this embodiment, the vehicular electronic device 260 may process restriction of outputting of at least a part of the screen data on the basis of the state information received from the OBD.

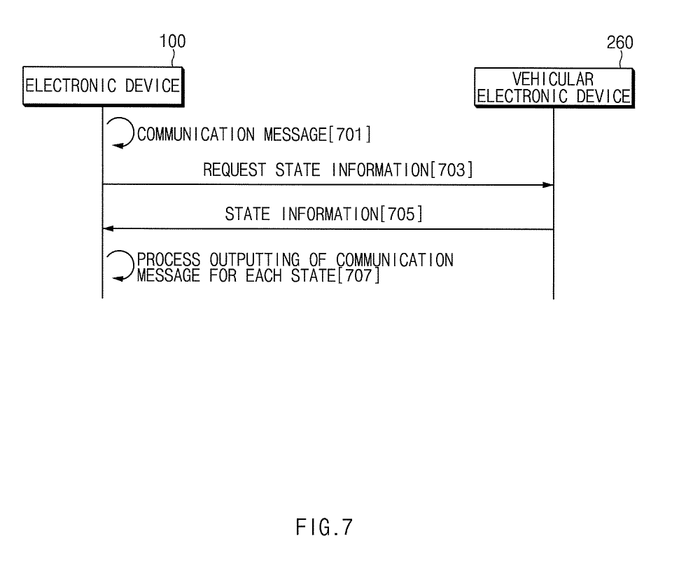

FIG. 7 illustrates a process for operating a system based on a movement state in relation to a communication message according to an embodiment.

Referring to FIG. 7, in operation 701, the electronic device 100 may receive a communication message. According to the various embodiments, upon receiving the communication message, the electronic device 100 may check whether the mobility support function is set. If the mobility support function is set, the electronic device 100 may request the state information from the vehicular electronic device 260 in operation 703. If the mobility support function is not set, the electronic device 100 may output the received communication message to the display module 140. According to the various embodiments, the electronic device 100 may automatically perform the mobility support function when entering the vehicle 200. To this end, the vehicular electronic device 260 may periodically output a scan signal related to scanning of the electronic device 100 in an ignition-started state. When the electronic device is arranged in the vehicle 200 and receives the scan signal from the vehicular electronic device 260, the electronic device 100 may automatically recognize that the electronic device 100 is in the vehicle. When the electronic device 100 recognizes that the electronic device 100 is in the vehicle, the electronic device 100 may perform the mobility support function. According to the various embodiments, when the electronic device 100 does not have the mobility support function, or the mobility support function is not activated, or the scan signal is not from the pre-registered vehicular electronic device 260, the mobility support function may be inactivated. For example, when the specific electronic device 100 registered as an electronic device of a vehicle driver enters the vehicle 200, the electronic device 100 may automatically perform the mobility support function on the basis of communication with the vehicular electronic device 260.

According to an embodiment, upon receiving the state information request from the electronic device 100, the vehicular electronic device 260 may transmit, to the electronic device 100, previously collected state information or state information collected at the time at which the state information request was received, in operation 705. In operation 707, the electronic device 100 may process outputting of the communication message for each state on the basis of the received state information. According to an various embodiments, the electronic device 100 may restrict the outputting of the communication message or may output predetermined guide information in response to the movement of the electronic device 100. According to the various embodiments, the electronic device 100 may notify the reception of the communication message or may output the communication message in response to stopping of the movement. For example, when the received communication message is a call connection request message, the electronic device 100 may be able to receive an input event related to a call connection. For example, the electronic device 100 may establish a call channel upon receiving the input event related to the call connection. The electronic device 100 may release the call channel when the state information is changed since the vehicle 200 is moved. In relation to this operation, when the state information is changed, the vehicular electronic device 260 may automatically transmit the changed state information to the electronic device 100.

According to the various embodiments, an information providing method based on a movement state may include receiving information related to movement of an electronic device or an external device (e.g., a vehicle or a vehicular electronic device) for the electronic device, and differently controlling, on the basis of the information, a function of an input device or output device of the electronic device or the external device, an application to be executed in the electronic device or the external device, or at least a part of a function of the application, with respect to a message received by the electronic device, by using at least one process.

According to the various embodiments, the information may be received from at least one sensor functionally connected to the electronic device or the external device.

According to the various embodiments, the differently controlling may be configured to provide a first user interface through the electronic device or the external device when a speed of the movement falls within a first speed range, and provide a second user interface obtained by deleting or modifying at least a part of information or functions related to the first user interface through the electronic device or the external device when the speed of the movement falls within a second speed range.

According to the various embodiments, the differently controlling may be configured to refrain from outputting information related to the message when the speed of the movement falls within a predetermined speed range, and output the information related to the message when the speed of the movement does not fall within the predetermined speed range.

According to the various embodiments, the receiving may be configured to receive traffic information obtained by at least one camera functionally connected to the electronic device or the external device as the information.

According to the various embodiments, the method may further include presenting, on the basis of the information, guide information related to the movement with respect to the message.

According to the various embodiments, the presenting the guide information may be configured to suspend the presenting of the guide information or change a presenting period when the electronic device or the external device is moved for at least a predetermined time or moved at a higher speed than a predetermined speed.

According to the various embodiments, the predetermined time or the predetermined speed may start to be measured from the time at which the guide information is presented.

According to an embodiment, an information providing method based on a movement state may include at least one of collecting movement-related state information of the electronic device 100, restricting outputting of at least a part of screen data to be output to a display module according to the movement-related state information, and restricting at least a part of an input function of the display module 140 and an input function of the input module 120.

According to the various embodiments, the collecting may include collecting the movement-related state information by using the sensor module 170 included in the electronic device 100, and receiving the movement-related state information from the vehicular electronic device 260 of the vehicle 200 in which the electronic device 100 is arranged.

According to the various embodiments, the collecting may include at least one of collecting at least one of a moving speed, a moving direction and a moving distance of the electronic device 100, collecting ambient weather condition information of the electronic device 100, and collecting information on conditions of a road on which the electronic device 100 is moved.

According to the various embodiments, the restricting outputting may include at least one of displaying objects included in screen data related to performance of a specific function after removing at least a part of the objects, displaying the objects as modified objects by modifying at least a part of the objects, and displaying the objects as modified objects by removing at least a part of the objects and modifying the remaining objects.

According to the various embodiments, the method may further include at least one of restoring the removed object to output the screen data according to a change of the movement-related state information, and restoring the modified object to output the screen data according to the change of the movement-related state information.

According to the various embodiments, the restricting at least a part of an input function may include at least one of disabling virtual key buttons of the display module 140 and disabling key buttons of the input module 120.

According to the various embodiments, the restricting at least a part of an input function may include enabling at least one of the virtual key buttons or at least one of the key buttons according to the moving speed of the electronic device 100, and enabling the disabled virtual key buttons of the display module 140 and the disabled key buttons of the input module 120 according to the change of the movement-related state information.

According to the various embodiments, the method may further include receiving a communication message including at least one of a one-time message including at least a part of a text and an image and a call connection-type message.

According to the various embodiments, the restricting outputting may include refraining from outputting the one-time message according to the movement-related state information when the electronic device is moved at a specific speed or higher.

According to the various embodiments, the method may further include providing a guide for receiving the communication message, or outputting predetermined guide information when the communication message on which the refraining from outputting is performed is accumulated as much as at least a specific number.

According to the various embodiments, the method may further include providing a guide for receiving a communication message, or outputting predetermined guide information when the communication message is received from a set another electronic device.

According to the various embodiments, the method may further include storing the communication message, and outputting the stored communication message according to the movement-related state information when the movement of the electronic device is stopped or the electronic device is moved at a specific speed or lower.

According to the various embodiments, the method may further include suspending the outputting of the communication message when the movement-stopped state is changed.

According to the various embodiments, the method may further include collecting traffic light information by enabling a camera module, and suspending the outputting of the communication message in response to a change of the traffic light information.

According to the various embodiments, the method may further include outputting a screen related to reception of the call-connection-type message according to the movement-related state information when the electronic device is stopped or moved at a specific speed or lower, and establishing a communication channel according to a call connection input event.

According to the various embodiments, the method may further include automatically release the call channel according to the movement-related state information when the electronic device is moved.

According to the various embodiments, the method may further include outputting predetermined guide information related to a movement state change in relation to the movement of the electronic device or checking of a communication message.

According to the various embodiments, the method may further include suspending the outputting of the predetermined guide information when the electronic device is moved at a specific speed or higher after a lapse of a specific time after outputting the predetermined guide information, and storing the communication message.

According to the various embodiments, the method may further include outputting the communication message when the electronic device is moved at a specific speed or lower or is stopped after outputting the predetermined guide information.

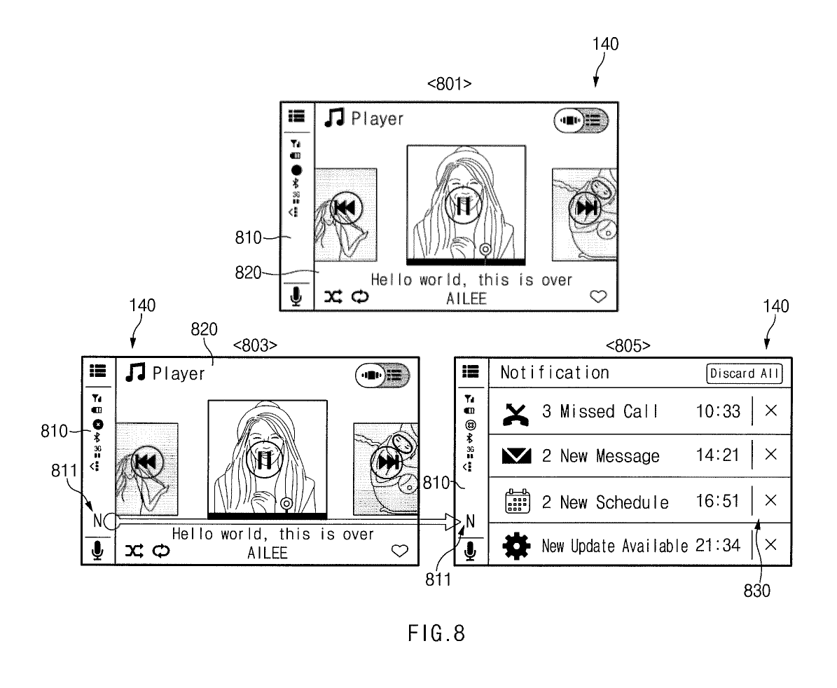

FIG. 8 illustrates a diagram showing a screen interface (or a user interface) related to processing of a communication message based on a movement state, according to an embodiment.

Referring to FIG. 8, according to an embodiment, the information providing module 180 of the electronic device 100 may allow a screen of state 801 to be output to the display module 140 in response to performance of a specific function, e.g., a sound source playback function. In state 801, the information providing module 180 may allow a screen including a sound source playback screen region 820 and a state region 810 to be output. The sound source playback region 820 may include screen data related to performance of functions. For example, the sound source playback screen region 820 may output a background image related to the sound source playback function and virtual control keys related to sound source playback control. The state region 810 may include various indicators or icons related to operation of the electronic device 100. For example, the state region 810 may output an indicator indicating an intensity of a receive signal related to the communication module 110 and an indicator indicating a remaining battery capacity.

According to an embodiment, the electronic device 100 may perform the mobility support function. When the communication message is received while the mobility support function is set and the electronic device 100 is moved, the electronic device 100 may refrain from notifying the reception of the communication message. Alternatively, when the communication message is received while the electronic device 100 is moved, the electronic device 100 may output predetermined guide information.

When the movement of the electronic device 100 is stopped, the electronic device 100 may output communication message-related information 811 as illustrated in state 803. The communication message-related information 811 may indicate the communication message received while the electronic device 100 is moved. The communication message-related information 811 may be arranged in the state region 810. According to the various embodiments, the communication message-related information 811 may be output to at least a part of the sound source playback screen region 820. In this operation, the communication message-related information 811 may be output to the sound source playback screen region 820 in the foam of a popup window when the movement of the electronic device 100 is stopped.

According to an embodiment, when an event of selecting the communication message-related information 811 occurs, the information providing module 180 may allow a screen including a communication message viewing region 830 or the state information 810 to be output to the display module 140 as illustrated in state 805. According to the various embodiments, when a specific time (e.g., 3 seconds, 5 seconds, 10 seconds, or a time set by a user) elapses after the movement of the electronic device 100 is stopped, the information providing module 180 may allow the screen including the communication message viewing region 830 to be automatically output. For example, the communication message viewing region 830 may be output to at least a part of the sound source playback screen region 820.

According to an embodiment, the communication message viewing region 830 may be output through an additional window. The communication message-related information 811 may be arranged on the state region 810. When a specific communication message is checked in the communication message viewing region 830, the communication message-related information 811 may be updated. For example, when a text message is checked in the communication message viewing region 830, the communication message-related information 811 may count and display the number of unchecked text messages.

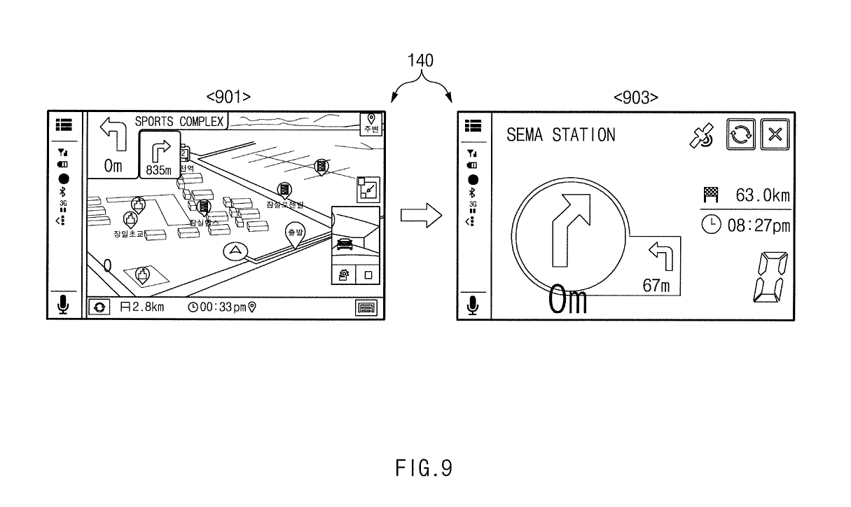

FIG. 9 illustrates a diagram showing an operation of processing function performance screen data (or user interface) based on a movement state according to an embodiment.

Referring to FIG. 9, according to an embodiment, the information providing module 180 may allow a navigation function performance screen to be output to the display module 140 in response to performance of a navigation function as illustrated in state 901. In relation to the performance of the navigation function, the information providing module 180 may allow map information to be output to the display module 140. Furthermore, the information providing module 180 may enable a location information collecting module such as a GPS module to collect current location information, and may display the collected current location information on the map information. To this end, the electronic device 100 may further include a GPS module.

The information providing module 180 may perform the mobility support function according to a preset configuration or an input event. The information providing module 180 may collect state information in response to performance of the mobility support function. As described above, the state information may be collected from at least one of the sensor module 170 or an external device (e.g., the vehicular electronic device 260). The information providing module 180 may modify or restrict at least a part of navigation screen data on the basis of the state information.

According to an embodiment, when the moving speed is higher than a preset speed, the information providing module 180 may modify an object of the screen data to output the modified object to the display module 140 as illustrated in state 903. Furthermore, the information providing module 180 may output a part of the screen data, e.g., direction information and distance information, to the display module 140. When the moving speed of the vehicle is decreased to the predetermined speed or lower, the information providing module 180 may allow the navigation screen data to the display module 140 as illustrated in state 901.

According to the various embodiments, when the degree of traffic congestion is at least a predetermined value, the information providing module 180 may change a screen state from state 901 into state 903 or vice versa. According to the various embodiments, the information providing module 180 may change the screen state from state 901 into state 903 or vice versa in response to a change of weather information. For example, when the weather is changed from serene weather into rainy or snowy weather, the information providing module 180 may change the screen state of the display module 140.

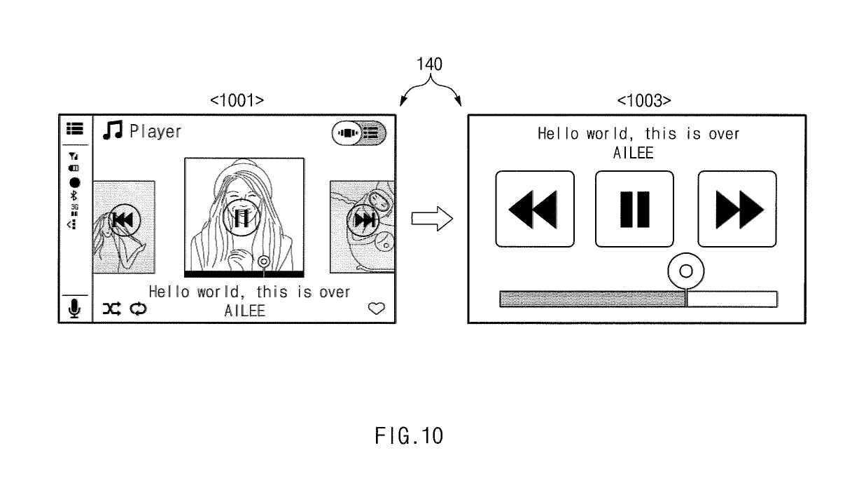

FIG. 10 illustrates a diagram showing an operation of processing function performance screen data (or user interface) based on a movement state according to the various embodiment.

Referring to FIG. 10, according to an embodiment, the information providing module 180 may allow a function performance screen corresponding to performance of a specific function such as a sound source playback function to be output to the display module 140 as illustrated in screen 1001. The function performance screen may include a background image object related to a sound source, a playback control key object related to playback of the sound source, and a state information object. Here, the state information object may include at least one indicator related to a state of the electronic device 100. The mobility support function may be being performed in the electronic device 100. Therefore, the function performance screen of screen 1001 may be a screen output when the movement of the electronic device 100 is stopped.

According to an embodiment, the information providing module 180 that is performing the mobility support function may collect the movement-related state information of the electronic device 100 in real time, or at a specific period, or in response to occurrence of an event. The information providing module 180 may determine whether the electronic device 100 is moved or determine ambient traffic conditions on the basis of the movement-related state information. When the electronic device 100 is moved after being stopped, the information providing module 180 may remove or modify at least one object included in the function performance screen to output the screen as illustrated in screen 1003. According to an embodiment, screen 1003 may be a screen obtained by modifying a control key object and removing the other objects from the function performance screen of screen 1001. According to the various embodiments, when the electronic device is stopped after being moved, the information providing module 180 may change screen 1003 into screen 1001.

According to the various embodiments, when the electronic device 100 is in a preset state, the information providing module 180 may change screen 1001 into screen 1003. Here, the preset state may be a state in which the degree of traffic congestion calculated on the basis of at least one of weather condition information and road condition information is at least a preset value, and, in this state, the information providing module 180 may change screen 1001 into screen 1003.

According to the various embodiments, the information providing module 180 may restrict at least a part of an input function according to the state information of the electronic device 100. For example, when the moving speed is changed, the information providing module 180 may disable virtual key buttons on at least one of screen 1001 and screen 1003. Accordingly, the information providing module 180 may restrict the input function through the display module 140. When the input function through the display module 140 is restricted, the information providing module 180 may output guide information in response to the restriction of the input function. For example, the information providing module 180 may output the guide information about the unavailability of the input function due to an increase of the moving speed.

According to the various embodiments, the information providing module 180 may allocate a virtual key button region to specific blocks on screen 1003, in response to the screen change from screen 1001 into screen 1003. The information providing module 180 may process an input event in which a touch occurs on the blocks on the display module 140. When the electronic device 100 is moved at a specific speed or higher, the information providing module 180 may disable the virtual control key buttons. When the moving speed is decreased to a specific speed or lower (e.g., less than 20 km/h, 30 km/h or 60 km/h), the information providing module 180 may restore the input function while changing screen 1001.

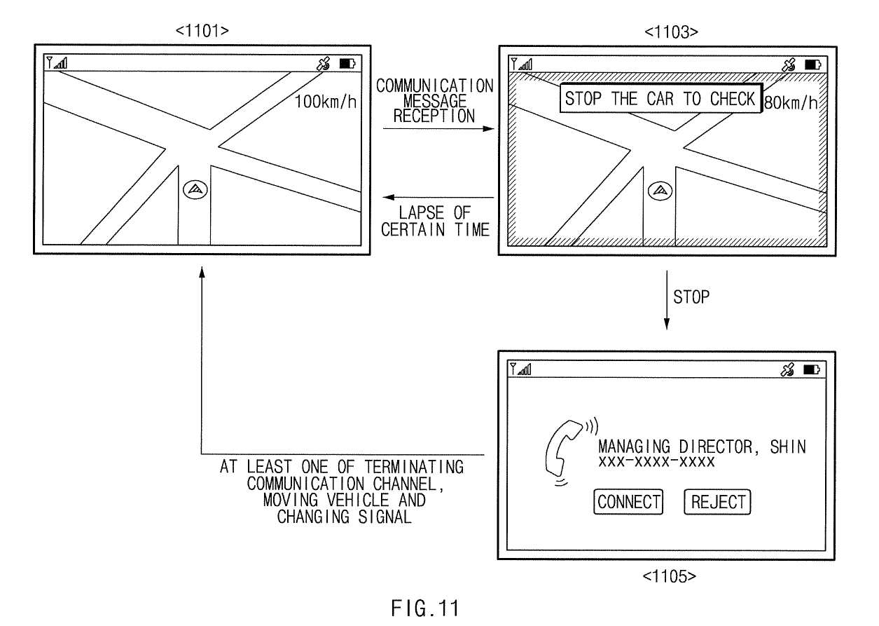

FIG. 11 illustrates a diagram showing a screen interface (or a user interface) related to processing of a communication message based on a movement state, according to the various embodiments.

Referring to FIG. 11, according to an embodiment, the information providing module 180 may allow a navigation function performance screen to be output to the display module 140 in response to performance of a navigation function as illustrated in state 1101. In this operation, the information providing module 180 may enable a GPS module in relation to collection of location information of the electronic device 100. The navigation function performance screen may include map information and current location information.

According to an embodiment, the information providing module 180 may enable the communication module 110 in relation to support of a communication function of the electronic device 100. The communication module 110 may have a communication standby state. The electronic device 100 may receive a communication message from another electronic device while performing a navigation function. For example, the electronic device 110 may receive a call connection request message from the other electronic device. Furthermore, the information providing module 180 may collect the movement-related state information using the sensor module 170 according to the mobility support function. The information providing module 180 may establish a communication channel to the vehicular electronic device 260 using the communication module 110, and may collect the state information from the vehicular electronic device 260. According to the various embodiments, the communication module 110 may receive a one-time message including at least one of a text and an image from another electronic device or a server device. In this embodiment, the information providing module 180 may determine, on the basis of the movement-related state information, whether to output the one-time message received without establishing a communication channel.

If it is determined that the electronic device 100 is being moved at the time at which the communication message is received, the information providing module 180 may output predetermined first guide information 1110 in response to the received communication message as illustrated in state 1103. The first guide information 1110 may include text information for inducing a user to stop the movement in relation to checking of the communication message. According to the various embodiments, the information providing module 180 may provide a screen display effect related to the reception of the communication message as second guide information 1130. The second guide information 1130 may be a display effect of flickering at at least a part of the display module 140. For example, the second guide information 1130 may be a display effect having a specific thickness and color flickering at an edge of the display module 140. According to the various embodiments, the second guide information 1130 may be provided in the form of audio data (e.g., a set guide sound or warning sound). According to the various embodiments, the second guide information 1130 may be provided in the form of a vibration having a predefined pattern.

When the movement of the electronic device 100 is stopped, the information providing module 180 may automatically notify the reception of the communication message as illustrated in state 1105. For example, the information providing module 180 may output virtual key buttons related to connecting or rejecting a call in response to a call connection request message. When an input event related to call connection occurs, the information providing module 180 may allow a communication channel to be established. When an input event related to call rejection occurs, the information providing module 180 may allow a call connection message to be transmitted to another electronic device. When the call channel is released, the information providing module 180 may allow the screen state to return to state 1101. Alternatively, when the state of the electronic device is changed to a state of being moved or a movement of at least a specific speed is detected, the information providing module 180 may allow the screen state to automatically return to state 1101. In this operation, the information providing module 180 may automatically release the call channel. According to the various embodiments, when the movement of the electronic device 100 is stopped, the information providing module 180 may allow a one-time message including at least a part of a text and an image to be output to the display module 140.

According to an embodiment, when a specific time elapses while the electronic device is moved in state 1103, the information providing module 180 may suspend the outputting of the first guide information 1110 and the second guide information 1130. Furthermore, the information providing module 180 may allow the screen state to return to state 1101. The information providing module 180 may store a received communication message. The information providing module 180 may record information about the received communication message. For example, if the movement is not stopped after the call connection request message is received, the information providing module 180 may record reception of a missed call message. The recorded call message may not be output while the electronic device 100 is moved, but may be automatically output to the display module 140 when the movement of the electronic device 100 is stopped.

According to the various embodiments, when at least a specific number of communication messages are accumulated in state 1101, the information providing module 180 may control the outputting of the guide information 1110 and 1130 related to the reception of the communication message as illustrated in state 1103. For example, when five or more communication messages are received, the information providing module 180 may control the outputting of the guide information 1110 and 1130 related to the reception of the communication message as illustrated in state 1103. For example, when five or fewer communication messages are received, the information providing module 180 may refrain from notifying the reception of the communication message or outputting the communication message as illustrated in state 1101.

According to the various embodiments, when at least a specific number of communication messages are received from another electronic device of the same type as the electronic device 100, the information providing module 180 may control the outputting of the guide information 1110 and 1130 related to the reception of the communication message. Here, the information providing module 180 may output guide information different from the first guide information 1110 and the second guide information 1130. For example, the information providing module 180 may output the guide information having a display effect of flickering the entire screen. Alternatively, the information providing module 180 may output text information larger than the first guide information 1110.

According to the various embodiments, when a communication message is received from a set another electronic device, the information providing module 180 may output predetermined guide information. In this operation, the information providing module 180 may output guide information different from that for the reception of another communication message. For example, the information providing module 180 may output guide information having a display effect different from that of the first guide information 1110 or the second guide information 1130. According to the various embodiments, when the communication message is received from the set another electronic device, the information providing module 180 may output the received communication message to the display module 140.

According to the various embodiments, the information providing module 180 may enable a camera module in state 1105. The information providing module 180 may photograph a traffic light and may collect traffic light information using the camera module. When the traffic light information collected by the camera module is changed, the information providing module 180 may allow the screen state to return to state 1101 from state 1105. For example, when the traffic light information collected by the camera module is a sign of allowing a vehicle to proceed (e.g., green light), the information providing module 180 may suspend the outputting of the communication message and allow the screen state to return to state 1101. In response to this operation, a user may recognize an alarm about the sign of allowing the vehicle to proceed and may move the vehicle when the outputting of the communication message is suspended.

As described above, according to the various embodiments, the electronic device 100 may be operated normally when the electronic device 100 is not moved or is moved at a specific speed or higher. For example, the electronic device 100 may restrict outputting of at least a part of screen data or may restrict at least a part of occurrence of an input event, while being moved. When the movement of the electronic device 100 is stopped, the electronic device 100 may output the screen data normally and may support the occurrence of the input event normally. Therefore, the electronic device 100 may prevent occurrence of an accident by means of at least one of the mobility support function or the mobility protection function. Here, the electronic device 100 may control the display module 140 and the input module 120 on the basis of not only whether the electronic device 100 is moved but also weather condition information or road condition information.

According to the various embodiments, the above-mentioned mobility support function or mobility protection function may be installed so as to be applied to a specific application. For example, the electronic device 100 may control the mobility support function or the mobility protection function such that the mobility support function or the mobility protection function is applied to a specific function that attracts attention of a user, such as a game function, a broadcast receiving function, or a video playback function. Furthermore, the electronic device 100 may provide an editing screen for allowing selection of at least one application to which the mobility support function or the mobility protection function is to be applied. Furthermore, the electronic device 100 may support the mobility support function or the mobility protection function such that the mobility support function or the mobility protection function is automatically applied to a specific application pursuant to relevant regulations of each nation. For example, the electronic device 100 may automatically apply the mobility support function or the mobility protection function to applications having a call function, a text messaging function, a broadcast receiving function, a video playback function, a game function, and the like.

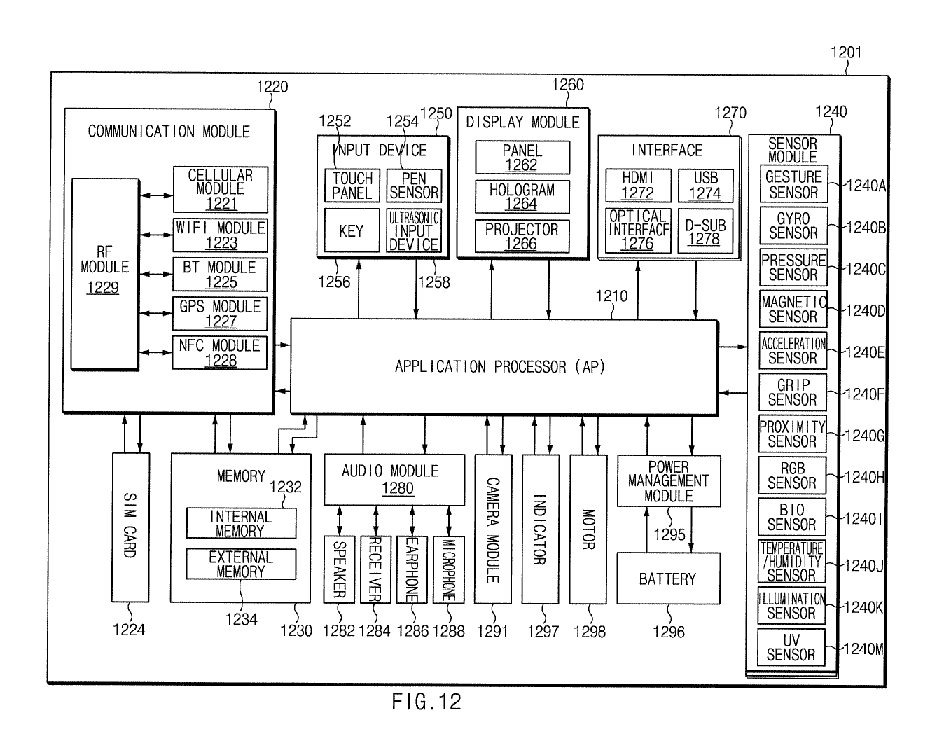

FIG. 12 illustrates a block diagram showing an electronic device 1201 according to the various embodiments.

The electronic device 1201 may constitute, for example, a part or the entirety of the electronic device 100 illustrated in FIG. 2. Referring to FIG. 12, the electronic device 1201 may include at least one application processor (AP) 1210 (e.g., at least one of the control module 160 and the information providing module 180), a communication module 1220 (e.g., the communication module 110), a subscriber identification module (SIM) card 1224, a memory 1230 (e.g., the storage module 150), a sensor module 1240 (e.g., the sensor module 170), an input device 1250 (e.g., the input module 120), a display 1260 (e.g., the display module 140), an interface 1270, an audio module 1280 (e.g., the multimedia module 130), a camera module 1291, a power management module 1295, a battery 1296, an indicator 1297 and a motor 1298.

The AP 1210 may run an operating system or an application program so as to control a plurality of hardware or software elements connected to the AP 1210, and may process various data including multimedia data and may perform an operation. The AP 1210 may be implemented with, for example, a system on chip (SoC). According to an embodiment, the AP 1210 may further include a graphic processing unit (GPU, not illustrated).

The communication module 1220 (e.g., the communication module 110) may perform data transmission/reception for communication between the electronic device 1201 (e.g., the electronic device 100) and other electronic devices connected thereto through a network. According to an embodiment, the communication module 1220 may include a cellular module 1221, a WiFi module 1223, a BT module 1225, a GPS module 1227, an NFC module 1228, and a radio frequency (RF) module 1229.

The cellular module 1221 may provide a voice call service, a video call service, a text message service, or an Internet service through a communications network (e.g., LTE, LTE-A, CDMA, WCDMA, UMTS, WiBro or GSM network). Furthermore, the cellular module 1221 may identify and authenticate electronic devices in the communications network using, for example, a subscriber identification module (e.g., the SIM card 1224). According to an embodiment, the cellular module 1221 may perform at least a part of functions provided by the AP 1210. For example, the cellular module 1221 may perform at least a part of a multimedia control function.

According to an embodiment, the cellular module 1221 may include a communication processor (CP). The cellular module 1221 may be implemented with, for example, an SoC. Although FIG. 12 illustrates that the cellular module 1221 (e.g., a communication processor), the memory 1230 and the power management module 1295 are separate from the AP 1210, the AP 1210 may include at least a part of the foregoing elements (e.g., the cellular module 1221), according to an embodiment.

According to an embodiment, the AP 1210 or the cellular module 1221 (e.g., a communication processor) may load, on a volatile memory, a command or data received from at least one of a nonvolatile memory and another element connected to the AP 1210 or the cellular module 1221, so as to process the command or data. Furthermore, the AP 1210 or the cellular module 1221 may store, in the nonvolatile memory, data received from or generated by at least one of the other elements.

Each of the WiFi module 1223, the BT module 1225, the GPS module 1227 and the NFC module 1228 may include, for example, a processor for processing data transmitted/received through the modules. FIG. 12 illustrates the cellular module 1221, the WiFi module 1223, the BT module 1225, the GPS module 1227 and the NFC module 1228 as if the modules are separate blocks. However, according to an embodiment, at least a part (e.g., two or more) of the cellular module 1221, the WiFi module 1223, the BT module 1225, the GPS module 1227 and the NFC module 1228 may be included in a single integrated chip (IC) or IC package. For example, at least a part (e.g., a communication processor corresponding to the cellular module 1221 and a WiFi processor corresponding to the WiFi module 1223) of the cellular module 1221, the WiFi module 1223, the BT module 1225, the GPS module 1227 and the NFC module 1228 may be implemented with a single SoC.

The RF module 1229 may transmit/receive data, for example, may transmit/receive an RF signal. Although not illustrated, for example, a transceiver, a power amp module (PAM), a frequency filter or a low noise amplifier (LNA) may be included in the RF module 1229. Furthermore, the RF module 1229 may further include a component such as a conductor or a wire for transmitting/receiving free-space electromagnetic waves in a wireless communication system. FIG. 12 illustrates the cellular module 1221, the WiFi module 1223, the BT module 1225, the GPS module 1227 and the NFC module 1228 as if the modules share the single RF module 1229. However, according to an embodiment, at least one of the cellular module 1221, the WiFi module 1223, the BT module 1225, the GPS module 1227 and the NFC module 1228 may transmit/receive RF signals through an additional RF module.

The SIM card 1224 may include a subscriber identification module, and may be inserted into a slot formed at a specific location of the electronic device. The SIM card 1224 may include unique identification information (e.g., an integrated circuit card identifier (ICCID)) or subscriber information (e.g., international mobile subscriber identity (IMSI)).

The memory 1230 (e.g., the storage module 150) may include an internal memory 1232 or an external memory 1234. The internal memory 1232 may include at least one of a volatile memory (e.g., a dynamic RAM (DRAM), a static RAM (SRAM) or a synchronous dynamic RAM (SDRAM)) and a nonvolatile memory (e.g., a one time programmable ROM (OTPROM), a programmable ROM (PROM), an erasable and programmable ROM (EPROM), an electrically erasable and programmable ROM (EEPROM), a mask ROM, a flash ROM, a NAND flash memory, or a NOR flash memory).

According to an embodiment, the internal memory 1232 may be a solid state drive (SSD). The external memory 1234 may include a flash drive, for example, compact flash (CF), secure digital (SD), micro secure digital (Micro-SD), mini secure digital (Mini-SD), extreme digital (xD) or a memory stick. The external memory 1234 may be functionally connected to the electronic device 1201 through various interfaces. According to an embodiment, the electronic device 1201 may further include a storage device (or a storage medium) such as a hard drive.

The sensor module 1240 (e.g., the sensor module 170) may measure physical quantity or detect an operation sate of the electronic device 1201 so as to convert measured or detected information into an electric signal. The sensor module 1240 may include, for example, at least one of a gesture sensor 1240A, a gyro sensor 1240B, an atmospheric pressure sensor 1240C, a magnetic sensor 1240D, an acceleration sensor 1240E, a grip sensor 1240F, a proximity sensor 1240G, a color sensor 1240H (e.g., RGB sensor), a biometric sensor 1240I, a temperature/humidity sensor 1240J, an illuminance sensor 1240K, and an ultraviolet (UV) sensor 1240M. Additionally or alternatively, the sensor module 1240 may include, for example, an olfactory sensor (E-nose sensor, not illustrated), an electromyography (EMG) sensor (not illustrated), an electroencephalogram (EEG) sensor (not illustrated), an electrocardiogram (ECG) sensor (not illustrated), an infrared (IR) sensor (not illustrated), an iris recognition sensor (not illustrated), or a fingerprint sensor (not illustrated). The sensor module 1240 may further include a control circuit for controlling at least one sensor included therein.

The input device 1250 may include a touch panel 1252 (e.g., the touch panel 141), a (digital) pen sensor 1254, a key 1256, or an ultrasonic input device 1258. The touch panel 1252 may recognize a touch input using at least one of capacitive, resistive, infrared and ultraviolet sensing methods. The touch panel 1252 may further include a control circuit. When using the capacitive sensing method, a physical contact recognition or proximity recognition is allowed. The touch panel 1252 may further include a tactile layer. In this embodiment, the touch panel 1252 may provide tactile reaction to a user.

The (digital) pen sensor 1254 may be implemented in a similar or same manner as that for receiving a touch input of a user, or may be implemented using an additional sheet for recognition. The key 1256 may include, for example, a physical button, an optical button, or a keypad. The ultrasonic input device 1258 may enable the electronic device 1201 to sense, through a microphone (e.g., a microphone 1288), sound waves from an input tool that generates ultrasonic signals so as to identify data, wherein the ultrasonic input device 1258 is capable of wireless recognition. According to an embodiment, the electronic device 1201 may use the communication module 1220 so as to receive a user input from an external device (e.g., a computer or a server) connected to the communication module 1220.

The display 1260 (e.g., the display module 140) may include a panel 1262 (e.g., the display panel 143), a hologram device 1264, or a projector 1266. The panel 1262 may be, for example, a liquid crystal display (LCD) or an active-matrix organic light-emitting diode (AM-OLED). The panel 1262 may be, for example, flexible, transparent or wearable. The panel 1262 and the touch panel 1252 may be integrated into a single module. The hologram device 1264 may display a stereoscopic image in a space using a light interference phenomenon. The projector 1266 may project light onto a screen so as to display an image. The screen may be arranged in the inside or the outside of the electronic device 1201. According to an embodiment, the display 1260 may further include a control circuit for controlling the panel 1262, the hologram device 1264, or the projector 1266.

The interface 1270 may include, for example, a high definition multimedia interface (HDMI) 1272, a universal serial bus (USB) 1274, an optical interface 1276, or a D-subminiature (D-sub) 1278. The interface 1270 may be included in the communication module 110 illustrated in FIG. 2. Additionally or alternatively, the interface 1270 may include, for example, a mobile high-definition link (MHL) interface, a secure digital (SD) card/multi-media card (MMC) interface, or an infrared data association (IrDA) interface.

The audio module 1280 may convert a sound into an electrical signal or vice versa. At least a part of the audio module 1280 may be included in the multimedia module 130 illustrated in FIG. 2. The audio module 1280 may process sound information input or output through a speaker 1282, a receiver 1284, an earphone 1286, or the microphone 1288.

The camera module 1291 for shooting a still image or a video may include at least one image sensor (e.g., a front sensor or a rear sensor), a lens (not illustrated), an image signal processor (ISP, not illustrated), or a flash (e.g., an LED or a xenon lamp, not illustrated).

The power management module 1295 may manage power of the electronic device 1201. Although not illustrated, a power management integrated circuit (PMIC), a charger integrated circuit (IC), or a battery or fuel gauge may be included in the power management module 1295.

The PMIC may be mounted on an integrated circuit or an SoC semiconductor. A charging method may be classified into a wired charging method and a wireless charging method. The charger IC may charge a battery, and may prevent an overvoltage or an overcurrent from being introduced from a charger. According to an embodiment, the charger IC may include a charger IC for at least one of the wired charging method and the wireless charging method. The wireless charging method may include, for example, a magnetic resonance method, a magnetic induction method or an electromagnetic method, and may include an additional circuit, for example, a coil loop, a resonant circuit, or a rectifier.

The battery gauge may measure, for example, a remaining capacity of the battery 1296 and a voltage, current or temperature thereof while the battery is charged. The battery 1296 may store or generate electricity, and may supply power to the electronic device 1201 using the stored or generated electricity. The battery 1296 may include, for example, a rechargeable battery or a solar battery.

The indicator 1297 may indicate a specific state of the electronic device 1201 or a part thereof (e.g., the AP 1201), such as a booting sate, a message sate, or a charging state. The motor 1298 may convert an electrical signal into a mechanical vibration. Although not illustrated, a processing device (e.g., a GPU) for supporting a mobile TV may be included in the electronic device 1201. The processing device for supporting a mobile TV may process media data according to the standards of digital multimedia broadcasting (DMB), digital video broadcasting (DVB) or media flow.

Each of the above-mentioned elements of the electronic device according to the present disclosure may be configured with one or more components, and the names of the elements may be changed according to the type of the electronic device. The electronic device according to the present disclosure may include at least one of the above-mentioned elements, and some elements may be omitted or other additional elements may be added. Furthermore, some of the elements of the electronic device according to the present disclosure may be combined with each other so as to form one entity, such that the functions of the elements may be performed in the same manner as before the combination.

The term “module” used herein may represent, for example, a unit including one or more combinations of hardware, software and firmware. The term “module” may be interchangeably used with the terms “unit”, “logic”, “logical block”, “component” and “circuit”. The “module” may be a minimum unit of an integrated component or may be a part thereof The “module” may be a minimum unit for performing one or more functions or a part thereof The “module” may be implemented mechanically or electronically. For example, the “module” according to the present disclosure may include at least one of an application-specific integrated circuit (ASIC) chip, a field-programmable gate array (FPGA), and a programmable-logic device for performing some operations, which are known or will be developed.

According to the various embodiments, at least a part of devices (e.g., modules or functions thereof) or methods (e.g., operations) according to the present disclosure may be implemented instructions stored in a computer-readable storage medium in the form of a programming module. When the instructions are performed by at least one processor (e.g., the processor 210), the at least one processor may perform functions corresponding to the instructions. The computer-readable storage medium may be, for example, the memory 120. At least a part of the programming module may be implemented (e.g., executed) by the processor 110. At least a part of the programming module may include, for example, a module, a program, a routine, sets of instructions, or a process for performing at least one function.

The computer-readable storage medium may include a magnetic medium such as a hard disk, a floppy disk and a magnetic tape, an optical medium such as a compact disk read only memory (CD-ROM) and a digital versatile disc (DVD), a magneto-optical medium such as a floptical disk, and a hardware device configured to store and execute program instructions (e.g., programming module), such as a read only memory (RAM), a random access memory (RAM) and a flash memory. The program instructions may include machine language codes made by compilers and high-level language codes that can be executed by computers using interpreters. The above-mentioned hardware may be configured to be operated as one or more software modules for performing operations of the present disclosure and vice versa.

The module or programming module according to the present disclosure may include at least one of the above-mentioned elements, or some elements may be omitted or other additional elements may be added. Operations performed by the module, the programming module or the other elements may be performed in a sequential, parallel, iterative or heuristic way. Furthermore, some operations may be performed in another order or may be omitted, or other operations may be added. Additionally or alternatively, at least a part of the module or the programming module or a function thereof may performed by a given electronic device (e.g., at least one of the electronic device 100 and the electronic device 1201) or may be performed by another electronic device (e.g., a server or a peer device) connected thereto functionally.

According to the various embodiments, a storage medium stores instructions configured to enable at least one processor to perform at least one operation when being executed by at least one processor, wherein the at least one operation may include receiving information related to movement of an electronic device or an external device outside the electronic device, and differently controlling, on the basis of the information, a function of an input device or output device of the electronic device or the external device, an application to be executed in the electronic device or the external device, or at least a part of a function of the application, with respect to a message received by the electronic device, by using at least one process.

As described above, according to the various embodiments, an electronic device may include a memory for storing information related to movement of the electronic device or an external device outside the electronic device, and a control module configured to control, when a speed of the movement is at least a predetermined speed on the basis of the information, at least a part of an input function, an output function, a specific application execution function or a function of an application being executed of at least one of the electronic device and the external device, in a different manner from that for a speed lower than the predetermined speed.

According to the various embodiments, the electronic device may further include at least one sensor for detecting at least a part of the information.

According to the various embodiments, the information may include at least one of a moving speed, a moving direction, a moving distance, a moving route, on-board diagnostics (OBD) information, weather condition information and road condition information of at least one of the electronic device and the external device.

According to the various embodiments, the control module may be configured to delete or modify at least a part of data currently displayed or to be displayed on the output device in response to the information.

According to the various embodiments, the control module may be configured to provide a first user interface through the electronic device or the external device when the speed of the movement falls within a first speed range, and provide a second user interface obtained by deleting or modifying at least a part of information or functions related to the first user interface through the electronic device or the external device when the speed of the movement falls within a second speed range, or may be configured to refrain from outputting the information when the speed of the movement falls within a predetermined speed range, and output the information when the speed of the movement is outside the predetermined speed range.

According to the various embodiments, the control module may be configured to receive traffic information obtained by at least one camera functionally connected to at least one of the electronic device and the external device as the information.

According to the various embodiments, the control module may be configured to present, on the basis of the information, guide information related to the movement with respect to the information.

According to the various embodiments, the control module may be configured to suspend the presenting of the guide information or change a presenting period when the electronic device or the external device is moved for at least a predetermined time or moved at a higher speed than a predetermined speed.

According to the various embodiments, the control module may be configured such that the predetermined time or the predetermined speed starts to be measured from the time at which the guide information is presented.

According to an embodiment, an information providing method may include receiving information related to movement of an electronic device or an external device outside the electronic device, and controlling, when a speed of the movement is at least a predetermined speed, at least a part of an input function, an output function, a specific application execution function or a function of an application being executed of at least one of the electronic device and the external device, using the information received from the electronic device and at least one process, in a different manner from that for a speed lower than the predetermined speed.

According to the various embodiments, the controlling may include deleting or modifying at least a part of data currently displayed or to be displayed on an output device of at least one of the electronic device and the external device in response to the information, providing a first user interface through the electronic device or the external device when the speed of the movement falls within a first speed range or providing a second user interface obtained by deleting or modifying at least a part of information or functions related to the first user interface through the electronic device or the external device when the speed of the movement falls within a second speed range, and refraining from outputting the information when the speed of the movement falls within a predetermined speed range or outputting the information when the speed of the movement is outside the first speed range.

According to the various embodiments, the receiving may be configured to receive traffic information obtained by at least one camera functionally connected to at least one of the electronic device and the external device as the information.

According to the various embodiments, the method may further include presenting, on the basis of the information, guide information related to the movement.

According to the various embodiments, the presenting the guide information may include suspending the presenting of the guide information or changing a presenting period when the electronic device or the external device is moved for at least a predetermined time or moved at a higher speed than a predetermined speed.

According to the various embodiments, a user is provided with a function for allowing the user to check information of en electronic device without interrupting movement of the user (e.g., walking, exercising or driving), such that the user can use the electronic device safely even when the user moves.

Furthermore, additionally or alternatively, the user is induced to change a movement state (e.g., decreasing the speed of walking or exercising or the vehicle speed, or stopping the vehicle) when the electronic device is used or relatively complicated manipulation is used, such that the user can use the electronic device safely.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An electronic device comprising:
a memory configured to store information related to movement of the electronic device or an external device outside the electronic device; and
a controller functionally connected to the memory, wherein the controller is configured to differently control, on the basis of the information, a function of an input device or an output device of a corresponding device from between the electronic device and the external device, an application to be executed in the electronic device or the external device, or at least a part of a function of the application with respect to a message received by the electronic device.

2. The electronic device according to claim 1, further comprising at least one sensor for detecting at least a part of the information.

3. The electronic device according to claim 1, wherein the information comprises at least one of a moving speed, a moving direction, a moving distance, a moving route, on-board diagnostics (OBD) information, weather condition information or road condition information of the electronic device or the external device.

4. The electronic device according to claim 1, wherein the controller is configured to delete or modify at least a part of data currently displayed or to be displayed on the output device in response to the message.

5. The electronic device according to claim 1, wherein the controller is configured to:
provide a first user interface through the electronic device or the external device when a s peed of the movement falls within a first speed range; and
provide a second user interface obtained by deleting or modifying at least a part of information or functions related to the first user interface through the electronic device or the external device when the speed of the movement falls within a second speed range.

6. The electronic device according to claim 5, wherein the controller is configured to:
refrain from outputting information related to the message when the speed of the movement falls within a predetermined speed range; and
output the information related to the message when the speed of the movement does not fall within the predetermined speed range.

7. The electronic device according to claim 1, wherein the controller is configured to receive traffic information obtained by at least one camera functionally connected to the electronic device or the external device as the information.

8. The electronic device according to claim 1, wherein the controller is configured to present, on the basis of the information, guide information related to the movement with respect to the message.

9. The electronic device according to claim 8, wherein the controller is configured to suspend the presenting of the guide information or change a presenting period when the electronic device or the external device is moved for at least a predetermined time or moved at a higher speed than a predetermined speed.

10. The electronic device according to claim 9, wherein the controller is configured such that the predetermined time or the predetermined speed starts to be measured from a time at which the guide information is presented.

11. A method comprising:
receiving information related to movement of an electronic device or an external device outside the electronic device; and
differently controlling, on the basis of the information, a function of an input device or output device of a corresponding device from between the electronic device and the external device, an application to be executed in the electronic device or the external device, or at least a part of a function of the application, with respect to a message received by the electronic device, by using at least one process.

12. The method according to claim 11, wherein the information comprises at least one of a stopped or moving state, a moving speed, a moving direction, a moving distance, a moving route, location information, or weather information or road information of the electronic device or the external device.

13. The method according to claim 11, wherein the differently controlling comprises deleting or modifying at least a part of data currently displayed or to be displayed on the output device in response to the message.

14. The method according to claim 11, wherein the differently controlling comprises:
providing a first user interface through the electronic device or the external device when a speed of the movement falls within a first speed range; and
providing a second user interface obtained by deleting or modifying at least a part of information or functions related to the first user interface through the electronic device or the external device when the speed of the movement falls within a second speed range.

15. The method according to claim 14, wherein the differently controlling comprises:
refraining from outputting information related to the message when the speed of the movement falls within a predetermined speed range; and
outputting the information related to the message when the speed of the movement does not fall within the predetermined speed range.

16. The method according to claim 11, wherein the receiving comprises receiving traffic information obtained by at least one camera functionally connected to the electronic device or the external device as the information.

17. The method according to claim 11, further comprising presenting, on the basis of the information, guide information related to the movement with respect to the message.

18. The method according to claim 17, wherein the presenting comprises suspending the presenting of the guide information or change a presenting period when the electronic device or the external device is moved for at least a predetermined time or moved at a higher speed than a predetermined speed.

19. The method according to claim 18, wherein the predetermined time or the predetermined speed starts to be measured from a time at which the guide information is presented.

20. A non-transitory computer readable medium embodying a computer program, the computer program comprising computer readable program code for:
receiving information related to movement of an electronic device or an external device outside the electronic device; and
differently controlling, on the basis of the information, a function of an input device or output device of the electronic device or the external device, an application to be executed in the electronic device or the external device, or at least a part of a function of the application, with respect to a message received by the electronic device, by using at least one process.
